(19) United States
(12) Patent Application Publication
(10) Pub. No.: US 2009/0193374 A1
(43) Pub. Date: Jul. 30, 2009

(54) METHOD OF DESIGNING SEMICONDUCTOR INTEGRATED CIRCUIT DEVICE, DESIGNING APPARATUS, AND SEMICONDUCTOR INTEGRATED CIRCUIT DEVICE

(76) Inventors: Kazuhiko FUJIMOTO, Hyogo (JP); Kenji Yokoyama, Kyoto (JP); Takeya Fujino, Osaka (JP); Takako Ohashi, Shiga (JP); Hiromasa Fukazawa, Hyogo (JP); Yohei Takagi, Kyoto (JP); Kazuhisa Fujita, Kyoto (JP)

Correspondence Address: MCDERMOTT WILL & EMERY LLP, 600 13TH STREET, NW, WASHINGTON, DC, 20005-3096, US

(21) Appl. No.: 12/352,206

(22) Filed: Jan. 12, 2009

(30) Foreign Application Priority Data
Jan. 10, 2008 (JP) P. 2008-003521

(51) Int. Cl. G06F 17/50

(52) U.S. Cl. 716/6

(57) ABSTRACT

As a method for considering the adverse influence of the stresses caused form the pad, two sorts of methods are provided. As one method, while delay variation values of cells caused by an adverse influence of stresses are calculated, the calculated delay variation values are applied to the cells so as to perform a timing analysis, and the like by considering the adverse influence of the stresses. Then, in order that a flip chip type LSI is designed by employing a result of the above-described analysis in such a manner that the adverse influence of the stresses applied from the pad is not given to vias, wiring lines, and cells located under the pad, such a physical structure that no via is arranged under the pad is employed.

### BACKGROUND OF THE INVENTION

1. Field of the Invention

The present invention is related to a method of designing a semiconductor integrated circuit device, a designing apparatus, and a semiconductor integrated circuit device. More specifically, the present invention is directed to design of a semiconductor integrated circuit device having a flip chip structure.

2. Description of the Related Art

In connection with very fine manufacturing techniques for recent semiconductor devices, quantities of transistors that constitute semiconductor integrated circuits (LSI) are steadily increased. In connection with increases in structural elements of LSI, there are some risks that chip areas of these LSI are increased. Accordingly, in view of cost matters, suppression of chip areas may provide the most important solving ideas.

In a system LSI, after a plurality of function blocks are formed on a silicon chip, circuit wiring lines for mutually and electrically connecting these function blocks are formed. In the above-described forming method, a large number of circuit wiring layers and a large number of insulating layers are stacked with each other. As a result, the below-mentioned problems may occur: That is, stresses are externally applied to these stacked circuit wiring/insulating layers, and stress migrations may occur, so that physical strength is reduced, electric connecting characteristics are lowered, and so on.

In order to solve the above-described problem, a patent publication 1 has disclosed such a technical idea that while a system LSI unit where a function block for realizing a function has been formed and a wiring layer unit used to connect this function block are separately prepared, these system LSI unit and wiring layer unit are adhered to each other so as to constitute an LSI.

However, in accordance with the solving method disclosed in the patent publication 1, masks are required to be independently formed with respect to the function block unit and the wiring layer unit. As a result, there is such a risk as to cost problems.

On the other hand, generally speaking, as methods for connecting semiconductor integrated circuits (LSI) with packages, wire bonding methods have been utilized. In the case that this wire bonding connecting method is employed, structures of LSI are made in such a manner that input/output cells (I/O cells) are arranged around IC chips. As a problem when this LSI structure is employed, areas of LSI chips depend upon quantities of these I/O cells. Moreover, in such a case that the above-explained wire bonding method is employed, wires must be adhered with respect to these I/O cells by applying thereto pressure. In order that the I/O cells are not destroyed by the pressure applying adhesion, dimensions of the I/O cells must be made larger than predetermined dimensions, which may have another implication that strength of these I/O cells is maintained at desirable strength. Further, since a preselected pressure-applied area is required, there is such a restriction that I/O cells cannot be physically made small. Under such a circumstance, if a total number of I/O cells employed in an LSI chip is increased in very fine process, then an area of the LSI chip is determined based upon the numbers of these I/O cells. As a consequence, even when area reducing process of internal logic is tried to be carried out by employing an placement synthesizing method, there is such a problem that the above-described area reducing process cannot give any contribution to the reduction of the chip area.

As solution ideas of the above-described problems, flip chip structures have been employed. FIG. 2 and FIG. 3 represent a general flip chip structure. A pad 12 constructed of an area pad 12a and bumps 12b connected to the area pad 12a is arranged over an entire plane of the flip chip, and this pad 12 is connected to I/O cells 11 by employing wiring lines 13. Furthermore, FIG. 2 shows a connecting method for the flip chip structure with respect to a package. An LSI 10 is connected to a wiring layer 21 of a package board 20 in a face down manner. Since the wire bonding process is no longer required with respect to the I/O cells 11, the dimensions of the I/O cells 11 can be made smaller than those of the conventional I/O cells. Also, since the I/O cells 11 themselves are not required to be arranged around the LSI 10, this flip chip structure can solve such a problem about the wire bounding manner, namely, the total number of I/O cells determines the area of the LSI. More specifically, in the below-mentioned description, the pad 12 arranged over the entire plane of the semiconductor integrated circuit chip by way of the flip chip system will be described as the area pad 12a and the bumps 12b.

As a problem that should be solved when a flip chip system is employed, there is an adverse influence caused by stresses that are applied from an area pad arranged on a front plane of an LSI to an LSI internal element. Since the external stresses are applied from the area pad, a portion of the LSI to which the stresses are applied, and another portion thereof to which the stresses are not applied are present in a mixture manner on the LSI. As an adverse influence caused by applying the stresses, there is such a risk that characteristics of transistors located just under the area pad are changed. Due to the adverse influences, response speeds of transistors contained in the LSI become unequal to each other, and then, if the above-described adverse influences are not considered, then there is a serious problem in timing reliability of the LSI. Also, if wiring lines and vias are present just under the area pad, then electric connections are damaged. As a result, not only there are some possibilities that electric connecting reliability is lowered, but also adverse influences may be given to timing reliability of the LSI, which are caused by an increase in wiring line resistances and a change in capacitances, which are caused by an increase in specific resistivity.

As a method capable of solving the above-described problem, a patent publication 2 has proposed such a method capable of reducing stresses in such a manner that when an LSI is mounted on a wiring board, at least 1 column of bumps is largely arranged from an outer edge of the LSI.

Patent Publication 1: JP-A-2001-024089

Patent Publication 2: JP-A-2001-118946

However, in the patent publication 2, since the pad is formed on the outer edge of the LSI, it is conceivable that the area of the LSI is increased and the area of the package is increased, which may cause a cost problem, and therefore, which cannot solve the essential problem. The changes in transistor characteristics, wiring resistances, and wiring capacitances, which are caused by the external stresses applied to the area pad when the wire bonding is performed, may constitute such a cause of variations in the characteristics of the LSI.

As a consequence, since the above-described characteristic variations of the LSI are present, the large margin must be made even when the LSI is designed, which may constitute various causes, namely, the design quality is lowered, and the area is increased due to the excessively large margin.

### SUMMARY OF THE INVENTION

The present invention has been made to solve the above-described problems, and therefore, has an object to provide a semiconductor integrated circuit device which cannot be adversely influenced by stresses, since process for solving the stress problems is executed at a stage when an LSI is designed.

More specifically, an object of the present invention is capable of optimizing a semiconductor integrated circuit device by analyzing the semiconductor integrated circuit device by considering an adverse influence of stresses, which is caused by a flip chip bonding method, and based upon the analysis result.

To solve the above-described problems, the present invention is featured by that an LSI (Large-Scaled Integration) is designed by considering adverse influences caused by stresses. This featured method is carried out as follows: That is, while degrees of magnitude and ranges given by the stresses have been previously acquired as data, the acquired data is utilized in delay calculations and also timing verification when the LSI is designed in order that the LSI is analyzed.

Then, since the LSI is optimized based upon the analysis result of this LSI, even when the adverse influences caused by the stresses are given, the LSI can be designed without any failure.

In addition, such an LSI structure is proposed in such a manner that transistors, wiring lines, and vias formed in the LSI are capable of suppressing an adverse influence of stresses caused by an area pad in a flip chip type LSI structure.

In the present specification, it is so assumed that a via may be formed by filling an electric conductive film which constitutes a wiring layer into a via hole which has been formed in an interlayer insulating film, and the above-described via designates an article formed by combing the via hole with the electric conductive film (wiring layer) filled into this via hole.

That is to say, a method for designing a semiconductor integrated circuit device, according to an aspect of the present invention, is featured by such a method for designing a semiconductor integrated circuit device comprising: a plurality of input/output cells; an area pad; and a re-wiring line for connecting at least a portion of the area pad to the input/output cells, in which the semiconductor integrated circuit device is connected via the area pad to wiring lines formed on a package board; wherein: the designing method is comprised of: a delay variation value calculating step for calculating a delay variation value which is applied to the target object, while considering an adverse influence of stresses received by that the area pad is connected to the wiring lines on the package board.

In accordance with the processing steps of the designing method, the LSI can be designed by considering the adverse influence of the stresses. As a result, it is possible to suppress occurrences of failures as to the LSI chip, which are caused by the stresses.

Also, a designing apparatus of a semiconductor integrated circuit device, according to another aspect of the present invention, is featured by such a designing apparatus of the semiconductor integrated circuit device which is equipped with: a plurality of input/output cells; an area pad; and a re-wiring line for connecting at least a portion of the area pad to the input/output cells, in which the semiconductor integrated circuit device is connected via the area pad to wiring lines formed on a package board; wherein: the designing apparatus is comprised of: an input unit for inputting layout information; and a delay variation value calculating unit for calculating a delay variation value which is applied to the target object, while considering an adverse influence of stresses received by that the area pad is connected to the wiring lines on the package board.

In accordance with the placements of the designing apparatus, the LSI can be designed by considering the adverse influence of the stresses. As a result, it is possible to suppress occurrences of failures as to the LSI chip, which are caused by the stresses.

Further, a semiconductor integrated circuit device, according to a further aspect of the present invention, is featured by that statuses of vias located within the preselected region under the area pad region are different from those of a peripheral region.

With employment of the above-described structure, the vias are adjusted in such a manner that the adverse influence of the stresses is adjusted. As a consequence, it is possible to provide a semiconductor integrated circuit device having higher reliability.

In accordance with the present invention, the LSI chips can be designed by considering the influences caused by the stresses in the flip chip structures. As a result, the failures of the LSI chips caused by the stresses can be prevented.

### BRIEF DESCRIPTION OF THE DRAWINGS

FIG. 1 is an explanatory diagram for indicating a concept of the present invention.

FIG. 2 is a diagram for showing a semiconductor integrated circuit device having a flip chip (BGA) structure.

FIG. 3 is a diagram for representing a terminal plane side of the semiconductor integrated circuit device having the flip chip (BGA) structure.

FIG. 4 is a diagram for showing a semiconductor integrated circuit designing apparatus according to an embodiment mode 1 of the present invention.

FIG. 5 is a flow chart for describing a delay variation calculating method in a semiconductor integrated circuit designing method of the embodiment mode 1 of the present invention.

FIG. 6 is a diagram for indicating a delay variation calculation example using the delay variation calculating method of FIG. 5.

FIG. 7 is a diagram for indicating a delay variation calculation example using the delay variation calculating method of FIG. 5.

FIG. 8 is a flow chart for describing the delay variation calculating method of FIG. 6.

FIG. 9 is a diagram for indicating a peripheral region of an area pad for explaining a delay variation calculating method in a semiconductor integrated circuit designing method according to an embodiment mode 2 of the present invention.

FIG. 10 is an equivalent circuit diagram for explaining the delay variation calculating method in the semiconductor integrated circuit designing method according to the embodiment mode 2 of the present invention.

FIG. 11 is an explanatory diagram for showing one example of a library employed in the delay variation calculating method in the semiconductor integrated circuit designing method according to the embodiment mode 2 of the present invention.

FIG. 12 is a flow chart for describing a delay variation calculating method in a semiconductor integrated circuit designing method according to an embodiment mode 3 of the present invention.

FIG. 13 is a flow chart for indicating another delay variation calculating method in the semiconductor integrated circuit designing method according to the embodiment mode 3 of the present invention.

FIG. 14 is a flow chart for describing a delay variation calculating method in a semiconductor integrated circuit designing method according to an embodiment mode 4 of the present invention.

FIG. 15 is a flow chart for indicating another delay variation calculating method in the semiconductor integrated circuit designing method according to the embodiment mode 4 of the present invention.

FIG. 16 is a flow chart for describing a delay variation calculating method in a semiconductor integrated circuit designing method according to an embodiment mode 5 of the present invention.

FIG. 17 is a flow chart for indicating another delay variation calculating method in the semiconductor integrated circuit designing method according to the embodiment mode 5 of the present invention.

FIG. 18 is a diagram for representing a library employed in a semiconductor integrated circuit designing method according to an embodiment mode 7 of the present invention.

FIG. 19 is a flow chart for describing a delay variation calculating method in a semiconductor integrated circuit designing method according to an embodiment mode 8 of the present invention.

FIG. 20 is a diagram for showing a layout example before an optimizing process is carried out by employing the delay variation calculating method in the semiconductor integrated circuit designing method according to the embodiment mode 8 of the present invention.

FIG. 21 is a diagram for representing a layout example after the optimizing process is carried out by employing the delay variation calculating method in the semiconductor integrated circuit designing method according to the embodiment mode 8 of the present invention.

FIG. 22 is a flow chart for describing an optimizing process by employing a delay variation calculating method in the semiconductor integrated circuit designing method according to an embodiment mode 9 of the present invention.

FIG. 23 is a diagram for representing a layout example after the optimizing process is carried out by employing the delay variation calculating method in the semiconductor integrated circuit designing method according to the embodiment mode 9 of the present invention.

FIG. 24 is a flow chart for describing an optimizing process by employing a delay variation calculating method in a semiconductor integrated circuit designing method according to an embodiment mode 10 of the present invention.

FIG. 25 is a diagram for showing a layout example after an optimizing process is carried out by employing a delay variation calculating method in a semiconductor integrated circuit designing method according to a embodiment mode 10 of the present invention.

FIG. 26 is a flow chart for describing an optimizing process by employing a delay variation calculating method in a semiconductor integrated circuit designing method according to an embodiment mode 11 of the present invention.

FIG. 27 is a flow chart for describing an optimizing process by employing a delay variation calculating method in a semiconductor integrated circuit designing method according to an embodiment mode 12 of the present invention.

FIG. 28 is a flow chart for describing an optimizing process by employing a delay variation calculating method in a semiconductor integrated circuit designing method according to an embodiment mode 13 of the present invention.

FIG. 29 is a diagram for representing a layout example after an optimizing process is carried out by employing a delay variation calculating method in a semiconductor integrated circuit designing method according to an embodiment mode 14 of the present invention.

FIG. 30 is a diagram for representing a layout example after an optimizing process is carried out by employing a delay variation calculating method in a semiconductor integrated circuit designing method according to an embodiment mode 15 of the present invention.

FIG. 31 is a diagram for representing a layout example after the optimizing process is carried out by employing the delay variation calculating method in the semiconductor integrated circuit designing method according to the embodiment mode 15 of the present invention (adverse influence of stresses by area pad is relaxed by bus wiring line).

FIG. 32 is a diagram for showing a layout example after an optimizing process is carried out by employing a delay variation calculating method in a semiconductor integrated circuit designing method according to an embodiment mode 16 of the present invention (dummy wiring line having wider width than that of area pad is employed).

FIG. 33 is a diagram for showing a layout example after an optimizing process is carried out by employing a delay variation calculating method in the semiconductor integrated circuit designing method according to the embodiment mode 16 of the present invention (adverse influence of stresses by area pad is relaxed by power wiring line).

FIG. 34 is a diagram for showing a layout example after an optimizing process is carried out by employing a delay variation calculating method in a semiconductor integrated circuit designing method according to an embodiment mode 17 of the present invention (construction density of dummy wiring lines of area pad is changed).

FIG. 35 is a diagram for showing a layout example after an optimizing process is carried out by employing a delay variation calculating method in a semiconductor integrated circuit designing method according to an embodiment mode 18 of the present invention (FIG. 35(a) shows reinforced portions constituted by vias and wiring layers, FIG. 35(b) indicates result obtained by that reinforced portions constituted by vias and wiring layers are longitudinally stacked from uppermost layer to lowermost layer).

FIG. 36 is a diagram for indicating a layout example after an optimizing process is carried out by employing a delay variation calculating method in the semiconductor integrated circuit designing method according to the embodiment mode 18 of the present invention (diagram for showing result obtained by that standard cell is prohibited to be arranged, and another result obtained by that longitudinally stacked reinforced portions constituted by vias and wiring layers are connected to substrate).

FIG. 37 is a diagram for indicating a layout example after an optimizing process is carried out by employing a delay variation calculating method in the semiconductor integrated circuit designing method according to the embodiment mode 18 of the present invention (diagram for showing result obtained by that standard cell is arranged into which longitudinally stacked reinforced portions constituted by vias and wiring lines have been embedded).

FIG. 38 is a diagram for indicating a layout example after an optimizing process is carried out by employing a delay variation calculating method in the semiconductor integrated circuit designing method according to the embodiment mode 18 of the present invention (diagram for showing result obtained by that portion of reinforced portions constituted by vias and wiring layers which have been longitudinally stacked is made small, and intermediate portion of reinforced portions constituted by vias and wiring layers which have been longitudinally stacked is made small).

FIG. 39 is a diagram for indicating a layout example after an optimizing process is carried out by employing a delay variation calculating method in the semiconductor integrated circuit designing method according to the embodiment mode 18 of the present invention (diagram for representing result obtained by that material is employed, hardness of which is higher than hardness of reinforced portion constructed of vias and wiring layers which have been longitudinally stacked).

FIG. 40 is a diagram for indicating a layout example after an optimizing process is carried out by employing a delay variation calculating method in an semiconductor integrated circuit designing method according to an embodiment mode 19 of the present invention (simplified diagram for indicating upper left corner of semiconductor integrated circuit).

FIG. 41 is a diagram for indicating a layout example after an optimizing process is carried out by employing a delay variation calculating method in a semiconductor integrated circuit designing method according to an embodiment mode 19 of the present invention (flow chart for placing longitudinally stacked reinforced portions constituted by vias and wiring layers after variation is verified).

FIG. 42 is a flow chart of describing an optimizing process by employing a delay variation calculating method in the semiconductor integrated circuit designing method according to the embodiment mode 19 of the present invention (flow chart for placing projection portions of wiring lines after neighbor portion is searched).

FIG. 43 is a flow chart for describing an optimizing process by employing a delay variation calculating method in the semiconductor integrated circuit designing method according to the embodiment mode 19 of the present invention (flow chart for performing timing verification and optimizing process).

### DESCRIPTION OF THE PREFERRED EMBODIMENTS

Referring now to drawings, a detailed description is made of various embodiment modes of the present invention.

### Embodiment Mode 1

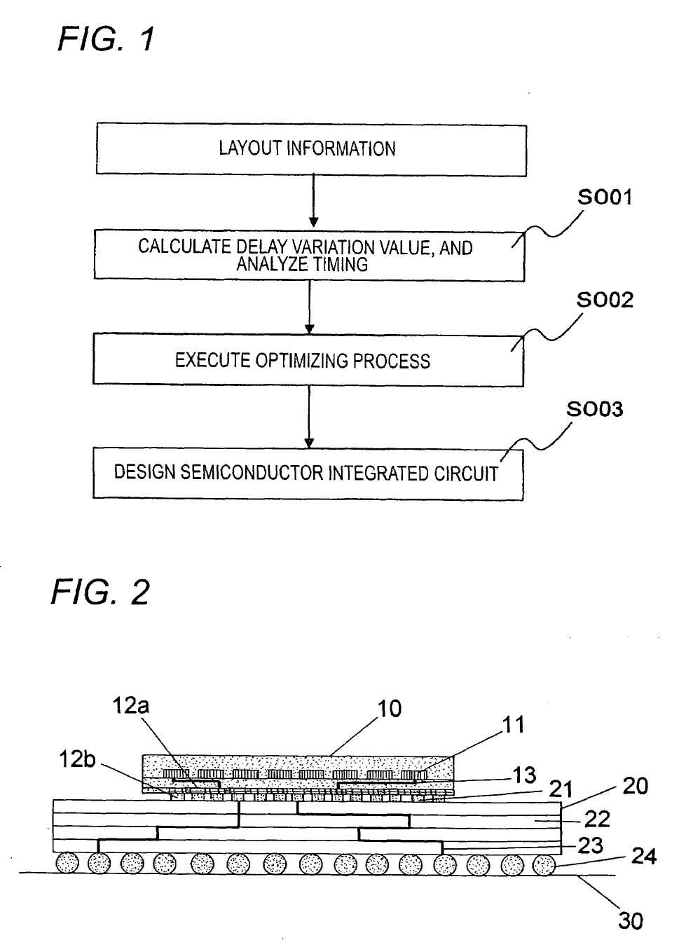

In an embodiment mode 1 of the present invention, in a flip chip type semiconductor integrated circuit device, the above-described semiconductor integrated circuit device (namely, LSI) is designed by considering stresses which are received from an area pad when being mounted. In this case, the embodiment mode 1 is featured as flows: That is, as represented in a summarized explanatory diagram of FIG. 1, while an arbitrary area pad is defined as a base point, delay variation values to be applied to a target object are calculated in response to distances from the base point up to the target object so as to perform a timing analysis, while the target object considers the above-described delay variation values (step S001). Based upon this calculation result, the LSI (semiconductor integrated circuit device) is optimized (step S002).

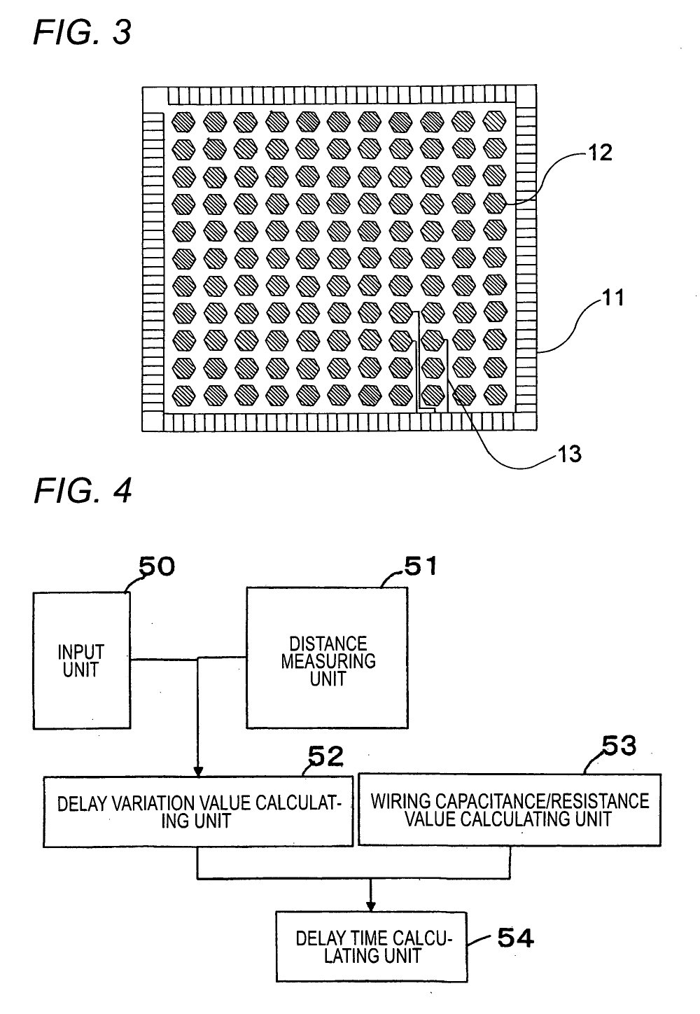

As shown in FIG. 2 and FIG. 3, the semiconductor integrated circuit device of the embodiment mode 1 is mounted based upon a so-called “BGA (Board Grid Array)” system. That is, a semiconductor integrated chip 10 equipped with a plurality of input/output (I/O) cells 11, an area pad 12a, and a re-wiring line (RDL) 13 which connects at least a portion of the area pad 12a to the above-described input/output cells 11 is connected via bumps 12b connected to the area pad 12a to a wiring line 21 formed on a package board 20.

While a plan view of the area pad 12a is shown in FIG. 3, the area pad 12a has been formed over an entire area of the semiconductor integrated circuit chip 10. The package board 20 is connected to a printed-circuit board 30 by a resin board 22 having a multilayer structure where the wiring line 21 has been formed; a through hole 23 formed in the respective resin boards, which connects the wiring line 21; and solder balls 24 formed on the side of a rear plane of such a resin board which constitutes the outermost layer.

As shown in FIG. 4, a designing apparatus used to design the above-described semiconductor integrated circuit device is provided with an input unit 50, a distance measuring unit 51, a delay variation value calculating unit 52, a wiring line capacitance/resistance values calculating unit 53, and a delay value calculating unit 54. The input unit 50 inputs layout information. The distance measuring unit 51 measures distances from layout information, while an area pad of a target object is defined as a base point. The delay variation value calculating unit 53 calculates delay variation values to be applied to the above-described target object by considering influences of stresses which are received by the area pad, since the area pad is connected to the wiring line formed on the package board. The wiring line capacitance/resistance values calculating unit 52 calculates a resistance value and a capacitance value of the wiring line by employing the delay variation values obtained by the delay variation value calculating unit 52. The delay value calculating unit 54 performs a delay calculation by employing the delay variation value calculated in the delay variation value calculating unit 53.

In this case, the delay variation value calculating unit 52 calculates delay variation values in correspondence with distances measured from the base point up to the target object while the area pad of the semiconductor integrated circuit device is used as the base point. Also, alternatively, while the delay variation value calculating unit 52 may be equipped with a library defined every cell, this delay variation value calculating unit 52 may calculate the delay variation values. Moreover, in the delay variation value calculating unit 52, while a database may be alternatively equipped with the above-described library, in which placing information and wiring information of the target object have been additionally stored, the delay variation value calculating unit 52 may alternatively calculate the above-described delay variation values.

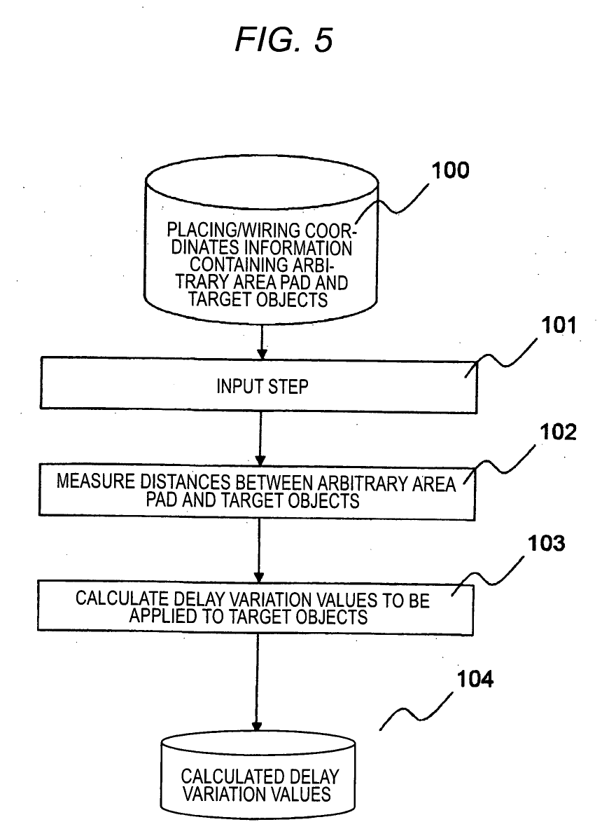

Next, a description is firstly made of a method for calculating a delay variation value prior to an explanation of a designing method with employment of the above-described designing apparatus. FIG. 5 is a flow chart for describing the delay variation value calculating method. As indicated in FIG. 4, in the designing apparatus for calculating a delay variation value 104, the input unit 50 inputs placing/wiring coordinates information 100 containing the arbitrary area pad 12a and target objects (step 101).

Then, the distance measuring unit 51 measures distances between the arbitrary area pad 12a and the target objects (step 102).

Also, the delay variation value calculating unit 52 calculates delay variation values based upon the measurement results (measured distances) obtained by the distance measuring unit 51 (step S103), and then, applies the calculated delay variation values to the target objects (step 104).

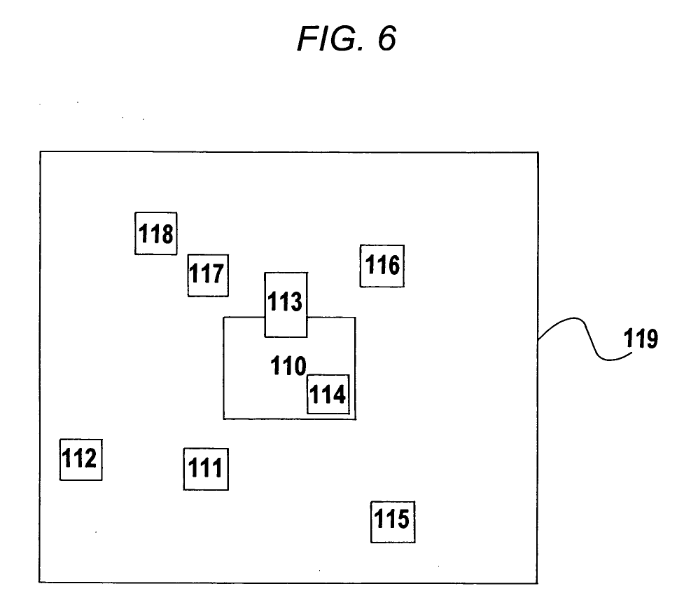

Next, referring to FIG. 6, a description is made of a delay variation value calculating method executed by the above-described delay variation value calculating unit 52. FIG. 6 is a diagram for showing an arbitrary area pad (object) that constitutes a base point, target objects, and variation amounts to be applied thereto.

While an attention is paid to an arbitrary area pad position 110, it is so assumed that as target objects 111, 112, 113, 114, 115, 116, 117, and 118, whose variation values are considered and which are located around the arbitrary area pad position 110, generally speaking, there are cells, wiring lines, and the like, namely these target objects indicate such target objects present on an LSI. In this example, an arbitrary boundary 119 represents a chip boundary, a block boundary, a different power supply voltage boundary, a different power source supply boundary, or an arbitrary boundary other than these boundaries.

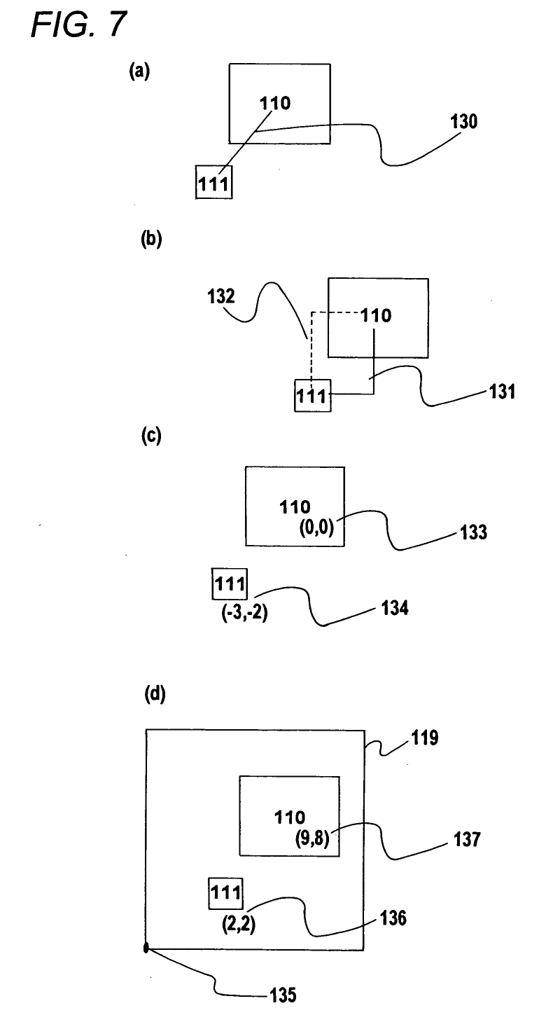

In order to calculate a delay variation value 104, in the distance measuring step 102 for measuring the distance between the arbitrary area pad and the target object, this delay variation value 104 may be calculated based upon distances calculated by employing an arbitrary calculation formula as follows: That is, based upon the placing/wiring coordinates information 100 containing the arbitrary area pad 12a and the target objects, distances defined from the arbitrary area pad position 110 up to the target objects 111, 112, 113, 114, 115, 116, 117, and 118, whose variation values are considered are calculated with employment of an arbitrary calculation formula, while considering either straight line distances or such distances when these target objects 111 to 118 are wired via the shortmost paths along horizontal and vertical directions, wiring line crowded situations, wiring prohibit areas, and the like. It is so assumed that both a starting point and an end point of measuring the distances are measured based upon distances between the arbitrary area pad position 110, and gravity centers as to the target objects 111 to 118 whose variation values are considered, or based upon distances among pins. Based upon the measurement result of the distance measuring step 102 for the arbitrary area pad 12a and the target objects 111 to 118, delay variation values (information) 104 are calculated in the delay variation value calculation step 103, while the delay variation values 104 are applied to these target objects 111 to 118 whose variation values are considered. Referring now to FIG. 7(a), a description is made of such a case that the delay variation value 104 which is applied to the target object 111 whose variation value is considered is measured based upon the straight line distance.

It is so assumed that a straight line distance from the arbitrary area pad position 110 up to the target object 111 whose variation value is considered is equal to a distance 130. It is also assumed that a variation value to be applied is 0.9 times larger than such a delay value which is held by a target object whose variation value is considered in response to a distance when the distance is 10 μm; a variation value to be applied is 0.8 times larger than such a delay value which is held by a target object whose variation value is considered in response to a distance when the distance is 20 μm; a variation value to be applied is 1.1 times larger than such a delay value which is held by a target object whose variation value is considered in response to a distance when the distance is 30 μm; and a variation value to be applied is 2 times larger than such a delay value which is held by a target object whose variation value is considered in response to a distance when the distance is 40 μm. In such a case that the distance 130 is 20 μm, the variation value to be applied to the target object 111 whose variation value is considered becomes 1.8 times larger than the above-described delay value, which is calculated in the delay variation value calculating step 103.

Also, in such a case that the distance 130 is 15 μm, it is so assumed that a variation value to be applied to the target object 111 is calculated by employing such a method that a linear interpolation is carried out based upon the variation amounts every distance have already been calculated before/after the distance 130 when the distances are 10 μm and 20 μm, or by employing other arbitrary calculation formulae.

For instance, in the linear interpolation method, the calculated variation value becomes 0.85. In a case where the distance 130 is 2 μm, 100 μm, or the like, namely, is largely deviated out of the range of the calculated variation amounts every distance, variation values to be applied to the target object 111 may be calculated to employing any one of the below-mentioned methods, namely, a method for employing such a value which is the shortmost value with respect to the calculated variation values every distance in view of a distance; another method for employing such a value which is the largemost value, or the smallmost value among the calculated variation values every distance; another method for employing a separately defined value; and a further method for employing other calculation formulae.

As a further example, the below-mentioned method is described with reference to FIG. 7(b) in such a case that the delay variation value 104 to be applied to the target object 111 whose variation value is considered is measured based upon distances when the target object 111 was wired to the arbitrary area pad position 110 via the shortmost paths along the horizontal direction and the vertical direction. It is so assumed that the wiring distances when the target object 111 was wired to the arbitrary area pad position 110 are a distance 131 and another distance 132. Although these distances 131 and 132 are equal to each other, these distances 131 and 132 are measured via different paths. The distance 131 corresponds to such an exemplification that the wiring line along the Y direction is utilized with a priority, whereas the distance 132 corresponds to such an exemplification that the wiring line along the X direction is utilized with a priority. In the delay variation value calculating step 103, any one of a method for considering the delay variation values in a batch manner without taking account of the distance along the X direction and the distance along the Y direction, and another method for handling the delay variation values by taking account of both the X direction and the Y direction.

The variation value calculating method for such a case that the distances along the X direction and the Y direction are considered in the batch manner is similar to the method described with reference to FIG. 7(a). In this case, a description is made of the method for handing the delay variation values by considering the X direction and the Y direction. Assuming now that the measurement result of the distance 131 is given as the X direction=2 μm and the Y direction=3 μm, a description is made of such a case that the measurement result of the distance 132 is given as the X direction=3 μm and the Y direction=2 μm.

In such a case that with respect to a delay value held by a target object whose variation value is considered in response to a distance, a variation value to be applied is 0.8 times when a distance of the X direction=1 μm; a variation value to be applied is 0.85 times when a distance of the X direction=5 μm; a variation value to be applied is 1 time when a distance of the X direction=10 μm; a variation value to be applied is 0.2 times when a distance of the Y direction=3 μm; a variation value to be applied is 0.8 times when a distance of the Y direction=5 μm; and, a variation value to be applied is 1 time when a distance of the Y direction=13 μm, there is no variation value every calculated distance under such a condition that the distance of the X direction=2 μm; and the distance of the Y direction=3 μm. As a result, assuming now that the linear interpolation is carried out, a variation value along the X direction becomes 0.83, and a variation value along the Y direction becomes 0.2. If both these variation values are averaged, then the delay variation value 104 to be applied to the target object 111 whose variation value is considered becomes 0.515. It should be noted that as the method for calculating the delay variation value 104, in addition to a method for averaging a variation value along the X direction and a variation value along the Y direction, any one of a square mean calculation method and other arbitrary calculation methods is employed.

As a still further example, a description is made of such a method for calculating the delay variation value 104 to be applied to the target object 111 whose variation value is considered with reference to FIG. 7(c) and FIG. 7(d). This example case is different from FIG. 7(a) and FIG. 7(b). That is, distances between the arbitrary area pad position 110 and the target object 111 whose variation is considered have been held as coordinate values, not by way of direct units, for example, “μm.” As to the coordinates, there are two patterns, namely, in addition to relative coordinates in which an arbitrary area pad shown in FIG. 7(c) is employed as a base point, there is another pattern that absolute coordinates at an arbitrary boundary 119 indicated in FIG. 7(d) are employed as a base.

Even also when the coordinate values are used, similar to FIG. 7(a) and FIG. 7(b), the distance measuring step 102 for measuring distances between the arbitrary area pads and the target objects is carried out via the input step 101. In the case of FIG. 7(c), in the distance measuring means for measuring the distance between the arbitrary area pad and the target object, coordinate values of the target object 111 whose variation value is considered are calculated as relative coordinate values between this target object 111 and the arbitrary area pad position 110. The relative coordinate values are calculated based upon a distance between the arbitrary area pad position 110 and a gravity center of the target object 111 whose variation value is considered, otherwise, a distance between pins. In the case of FIG. 7(d), when the coordinates which have been defined as the placing/wiring coordinates information 100 containing the arbitrary area pads and the target objects correspond to such coordinates calculated based upon the arbitrary boundary 119, the step 102 for measuring the distance between the arbitrary area pad and the target object may be omitted.

However, in such a case that the coordinates described in the placing/wiring coordinates information 100 containing the arbitrary area pad and the target object are such coordinates described on the basis different from the arbitrary boundary 119, the distance measuring step 102 for measuring the distance between the arbitrary area pad and the target object is executed in a similar to that of FIG. 7(c). Also, in the distance measuring step 102 between the arbitrary area pad and the target object in the case of FIG. 7(d), while such coordinates that the arbitrary area pad position 110 is employed as the base point are not acquired, an absolute distance from an arbitrary base point 135 within the arbitrary boundary 119 is calculated. In this case, this absolute distance is calculated between the arbitrary base point 135 and a gravity center of the target object 111 whose variation value is considered.

Next, in the delay variation value calculating step 103, a delay variation value 104 to be applied to the target object 111 whose variation value is considered is calculated based upon the coordinate 134 and the coordinate 135, which have been acquired as the coordinates of this target object 111 whose variation is considered. In this case, different from the above-explained cases shown in FIG. 7(a) and FIG. 7(b), the delay variation values 104 which should be applied to the target object 111 are determined based upon not the distances, but the coordinate positions. As a consequence, in the delay variation value calculating step 103, based upon a variation value every coordinate, which has been previously calculated by a formula, a variation value to be applied to the target object 111 whose variation value is considered is calculated from the coordinate 134 and the coordinate 135 corresponding to the coordinate information of the target object 111 whose variation value is considered.

As previously described, in accordance with the above-described embodiment mode 1, the influences of the stresses given from the area pad can be applied to the specific object. As a result, while the influences of the stresses are considered, the delay calculation, the timing analysis, and the like can be carried out. Then, the layout design of the LSI is optimized based upon this timing analysis result, while the layout covers structures, placements, and shapes of vias, and also, placements of cells (will be discussed later). As a consequence, it is possible to prevent the failures of the LSI, which are caused by the delay variations by the stresses.

Also, since the margin is no longer required, the semiconductor integrated circuit device can be made compact.

### Embodiment Mode 2

In the above-described embodiment mode 1, the delay variation values have been calculated by employing the distance measuring step for measuring the distances between the arbitrary area pad and the target objects. In an embodiment mode 2 of the present invention, a description is made of such a method that while a variation value definition library has been previously prepared, a delay variation value is acquired by employing this definition library.

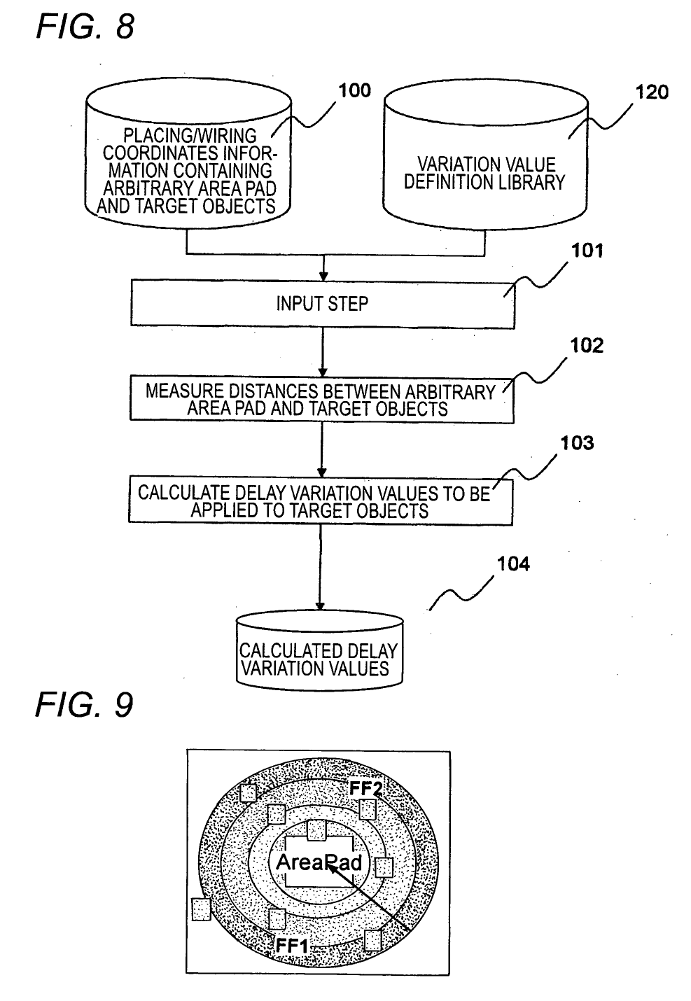

The variation information which constitutes the base of the delay variation value calculated in the delay variation value calculating step 103 described in the above-described embodiment mode 1 is calculated in accordance with the arbitrary calculation formula in the delay variation value calculation step 101. In addition to this calculation method, another method is present: That is, as represented in a flow chart for describing a delay variation value calculating method in FIG. 8, while a variation value definition library 120 is installed, a variation delay value is inputted from this variation value definition library 120. This method has only such a different process step that the variation delay value is entered from the variation definition library 120 in addition to the wiring/placing coordinates information 100 containing the arbitrary area pad and the target object in an input step 101, as compared with the flow chart of FIG. 5 explained in the above-described embodiment mode 1, and other process steps thereof are similar to those of the embodiment mode 1.

It is so assumed that 3 sorts of methods for defining variation amounts are present in the variation value definition library 120: That is, a method is to define distances along the X direction and the Y direction and variation amounts, or to define a total distance which does not take care of the X direction and the Y direction, and a variation amount corresponding to the total distance; and another method is to define variation amounts with respect to coordinates.

Moreover, variation information acquired by employing arbitrary calculation formulae and libraries may alternatively have different values in correspondence with the below-mentioned items: sorts (cell name, transistor derivability of final stage of cell, use field of cell such as clock exclusively-used cell, cell logic attribute, wiring line, capacitance, resistance etc.) of the target object 111 whose variation value is considered; coarse/fine degrees of cells and wiring lines within a range which has been separately set from the target object 111 whose variation value is considered; a voltage drop amount, a delay variation amount caused by a crosstalk, and Setup/Hold when a timing analysis is performed as to the target object 111 whose variation value is considered; where the target object 111 whose variation value is considered is present on the transmission side, on the reception side within a timing path, and in clock data; and verification corners (temperature, process, voltage, Vth).

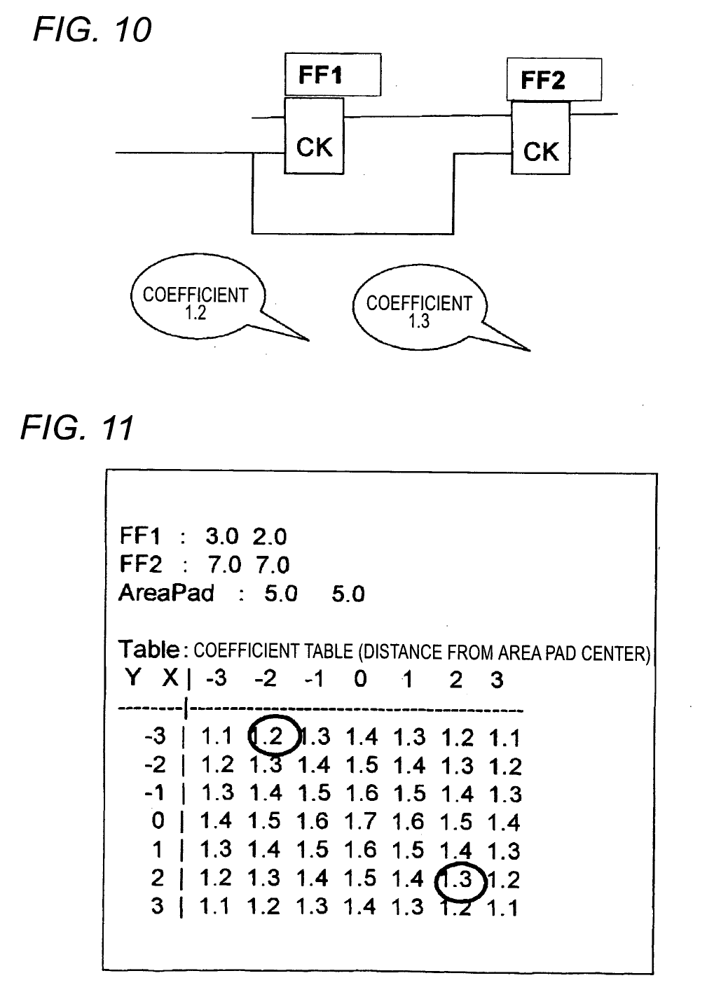

FIG. 9 to FIG. 11 are explanatory diagrams for explaining a variation value definition library. While an attention is paid to an area pad peripheral region as shown in FIG. 11, it is so assumed that both a transistor circuit for constructing a first flip-flop “FF1”, and another transistor circuit for constituting a second flip-flop “FF2” correspond to (3, 2) and (7, 7) respectively when positional coordinates of the area pad are defined as (5, 5). Also, as shown in FIG. 10, when such an LSI is conceived that the second flip-flop “FF2” is located at a post stage with respect to the transistor circuit which constitutes the first flip-flop “FF1”, coefficients are assumed as 1.2 and 1.3 respectively, and thus, one example of the variation value definition library is represented in FIG. 11.

As previously described, in accordance with the embodiment mode 2, since the variation value definition library is employed which has been previously defined, while the processing time can be shortened, the delay variation values with respect to the arbitrary area pad can be calculated.

### Embodiment Mode 3

In an embodiment mode 3 of the present invention, a description is made of a method for executing a timing analysis by employing a delay variation value 104 to be applied to a target object whose delay variation value is considered, and the above-described delay variation value 104 has been obtained in response to a distance from a base point up to the target object whose delay variation value 104 is considered while an arbitrary area pad is defined as the base point.

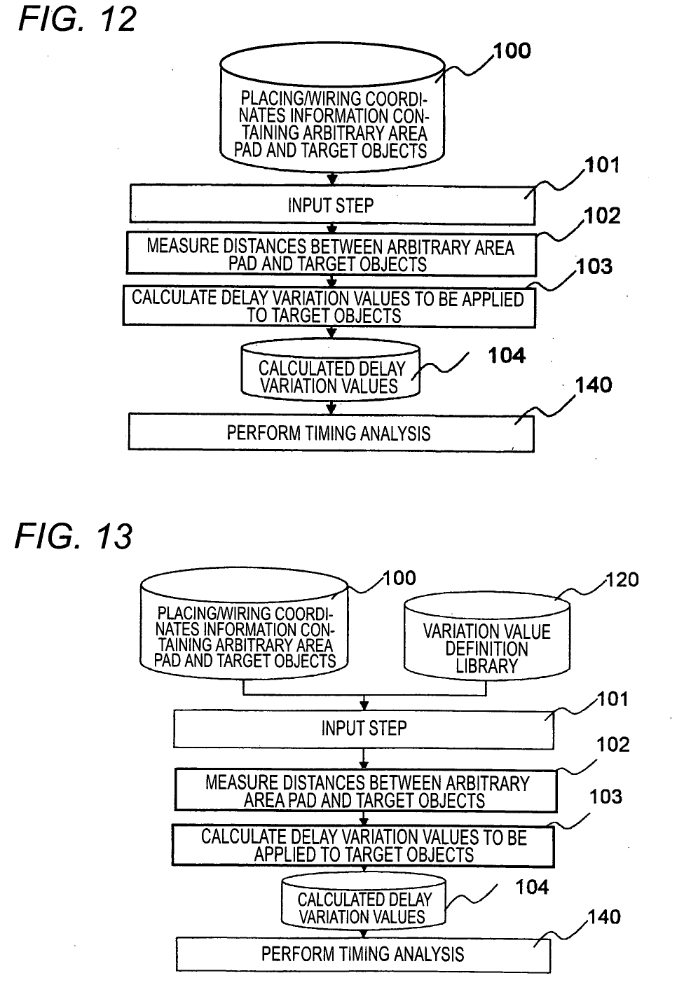

FIG. 12 is a flow chart for showing a timing analyzing method executed based upon a delay variation value. This designing apparatus may be obtained by adding a timing analyzing unit to the apparatus shown in FIG. 4, and is equipped with: an input unit 101 for inputting placing/wiring coordinates information 100 containing an arbitrary area pad and a target object; a distance measuring unit 102 for measuring a distance between the arbitrary area pad and the target object; a delay variation value calculating unit 103 for calculating a delay variation value to be applied to the target object; and a timing analyzing unit (not shown).

As represented in FIG. 12, contents of the timing analyzing method of the embodiment mode 3 defined from the input step 101 via the distance measuring step 102 for measuring the distance between the arbitrary pad and the target object until the delay variation value calculating unit 103 for applying the delay variation value to the target object are similar to those of the timing analyzing method explained in the embodiment mode 1. In this embodiment mode 3, as indicated in FIG. 12, the delay variation value 104 obtained in the delay variation value calculating step 103 for applying the delay variation value to the target object is applied to the target objects 111, 112, 113, 114, 115, 116, 117, and 118, whose variation values are considered as coefficients so as to perform a timing analysis (step 140). Alternatively, the delay variation value 104 obtained in the delay variation value calculating step 103, which is applied to the target objects, may have different values in response to “Hold” verification, “Setup” verification, such a case that the target objects 111, 112, 113, 114, 115, 116, 117, and 118 whose variation values are considered are present on the launch path side, such a case that the target objects 111 to 118 whose variation values are considered are present on the capture path side, and furthermore, a verification corner, and so on. In the timing verifying step 140, the below-mentioned timing verification is featured by that the delay variation value 104 obtained in the delay variation value calculating step 103, which is applied to the target objects, is used as the coefficient in accordance with a condition for executing the timing verification.

As previously described, in accordance with the embodiment mode 3, the timing analysis can be carried out, by employing the calculated delay variation value.

It should be understood that although the above-described embodiment mode has exemplified such an example that the delay variation value is calculated, as indicated in FIG. 13, the timing analyzing method of this embodiment mode 3 may be similarly realized even in such a case that as represented in FIG. 13, the delay variation value library is employed. In this alternative case, although a detailed explanation is omitted, there is only such a different process operation that a step for reading a corresponding delay variation value from the delay variation value library 120 is added to the input step 101, and other process operations are similar to those of the flow chart shown in FIG. 12.

### Embodiment Mode 4

In an embodiment mode 4 of the present invention, a description is made of a method for calculating a resistance value and a capacitance value of a wiring line by employing a delay variation value to be applied to a target object whose delay variation value is considered in response to a distance from a base point up to the target object whose delay variation value is considered, while an arbitrary area pad is defined as the base point.

The calculating method of the embodiment mode 4 is featured by that the resistance value and the capacitance value of the wiring line based upon the delay variation value 104 to be applied to the target object, which has been calculated in the embodiment mode 1.

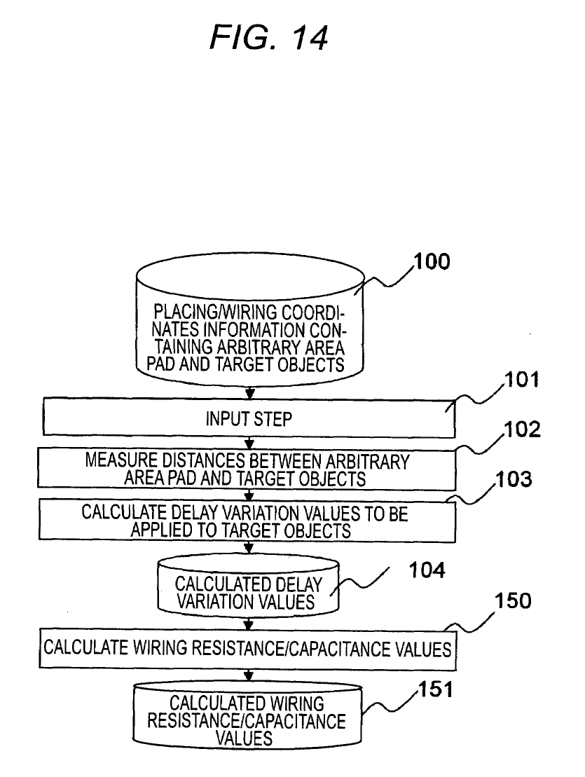

FIG. 14 is a flow chart for showing a method of calculating a resistance value and a capacitance value of a wiring line based upon the delay variation value 104. As indicated in FIG. 4, this designing apparatus is equipped with the wiring line resistance/capacitance calculating unit 53, while the wiring line resistance/capacitance calculating unit 53 calculates the resistance value and the capacitance value of the wiring line based upon the delay variation value 104 calculated in the delay variation value calculating unit 52.

In order to calculate both the resistance value and the capacitance value by employing the above-described designing apparatus, the wiring line resistance/capacitance values calculating method is provided with: an input step 101 for inputting placing/wiring coordinates information 100 containing an arbitrary area pad and a target object; a distance measuring step 102 for measuring a distance between the arbitrary area pad and the target object; a delay variation value calculating step 103 for calculating a delay variation value to be applied to the target object; and also, a wiring resistance/capacitance calculating step 150 for calculating a wiring resistance value and a wiring capacitance value.

The above-described input step 101 and distance measuring step 102 for measuring the distance between the arbitrary area pad and the target object are completely identical to the means described in the embodiment mode 1. Next, in the wiring resistance/capacitance calculating step 150, the delay variation value 104 calculated in the delay variation value calculating step 103 for applying the delay variation value 104 to the target object is applied as the wiring resistance/capacitance values to the target objects 111, 112, 113, 114, 115, 116, 117, 118, whose variation values are considered so as to form wiring resistance/capacitance information 151.

As previously described, in accordance with the embodiment mode 4, the wiring resistance/capacitance values can be calculated by considering the stresses given from the area pad. As a consequence, the delay calculation and the timing calculation can be carried out in a more correct manner.

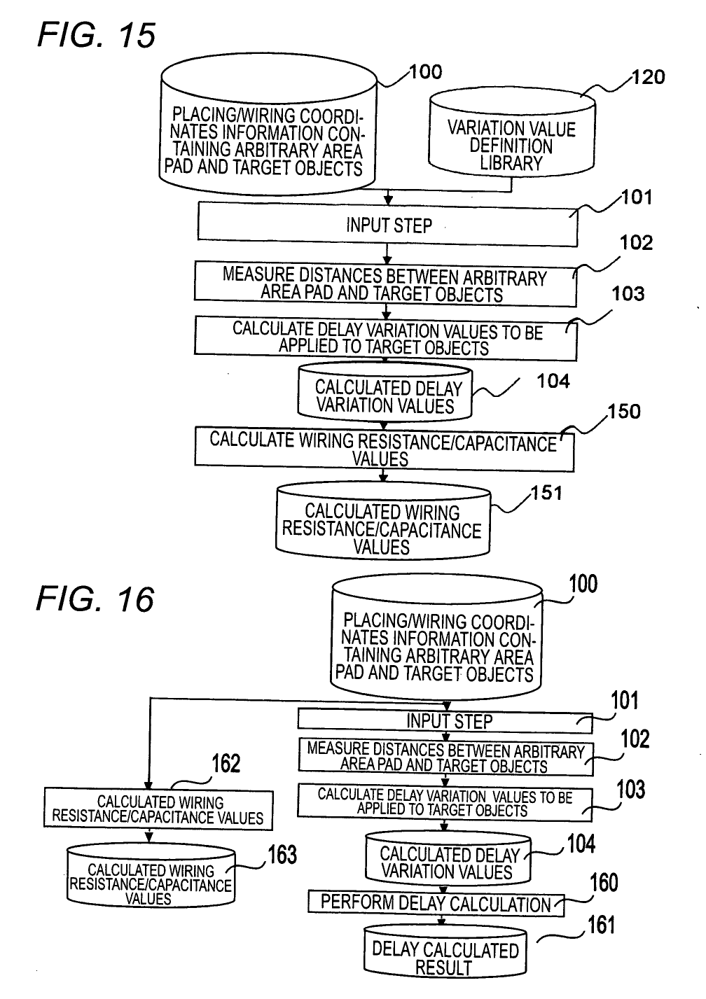

It should be understood that although the above-described embodiment mode has exemplified such an example that the delay variation value is calculated, as indicated in FIG. 15, the timing analyzing method of this embodiment mode 4 may be similarly realized even in such a case that as represented in FIG. 14, the delay variation value library is employed. In this alternative case, although a detailed explanation is omitted, there is only such a different process operation that a step for reading a corresponding delay variation value from the delay variation value library 120 is added to the input step 101, and other process operations are similar to those of the flow chart shown in FIG. 14.

### Embodiment Mode 5

In an embodiment mode 5 of the present invention, a description is made of a method for performing a delay calculation by employing a delay variation value to be applied to a target object whose delay variation value is considered in response to a distance from a base point up to the target object whose delay variation value is considered, while an arbitrary area pad is defined as the base point.

The delay calculating method of the embodiment mode 5 is featured by that based upon the delay variation value 104 to be applied to the target object, which has been calculated in the embodiment mode 1, a delay calculation is carried out.

FIG. 16 is a flow chart for showing a delay calculating method based upon the delay variation value 104. As indicated in FIG. 4, this designing apparatus is equipped with the wiring line resistance/capacitance calculating unit 53, and a delay value calculating unit 54, while the wiring line resistance/capacitance calculating unit 53 calculates the resistance value and the capacitance value of the wiring line based upon the delay variation value 104 calculated in the delay variation value calculating unit 52. In order to perform a delay calculation by employing the above-described designing apparatus, as indicated in FIG. 4, the delay calculating method is provided with: an input step 101 for inputting placing/wiring coordinates information 100 containing an arbitrary area pad and a target object; a distance measuring step 102 for measuring a distance between the arbitrary area pad and the target object; a delay variation value calculating step 103 for calculating a delay variation value to be applied to the target object; a delay calculating step 160; and also, a wiring resistance/capacitance calculating step 162.

The above-described input step 101 and distance measuring step 102 for measuring the distance between the arbitrary area pad and the target object are completely identical to the means described in the embodiment mode 1. Next, the wiring resistance/capacitance calculating step 162 is executed based upon the placing/wiring coordinates information 100 containing the arbitrary area pad and the target object so as to acquire wiring line resistance/capacitance information 163. The delay calculating step 160 is executed by employing the wiring line resistance/capacitance information 163 and the delay variation value 104 in order to produce a delay calculation result 161.

In the delay calculation step 160, the delay variation value 104 is utilized as a coefficient during a delay calculation so as to perform the delay calculation.

As previously described, in accordance with the embodiment mode 5, the delay calculation can be carried out by considering the stresses given from the area pad, and thus, this can avoid erroneous operation of the LSI, which are caused by the stresses.

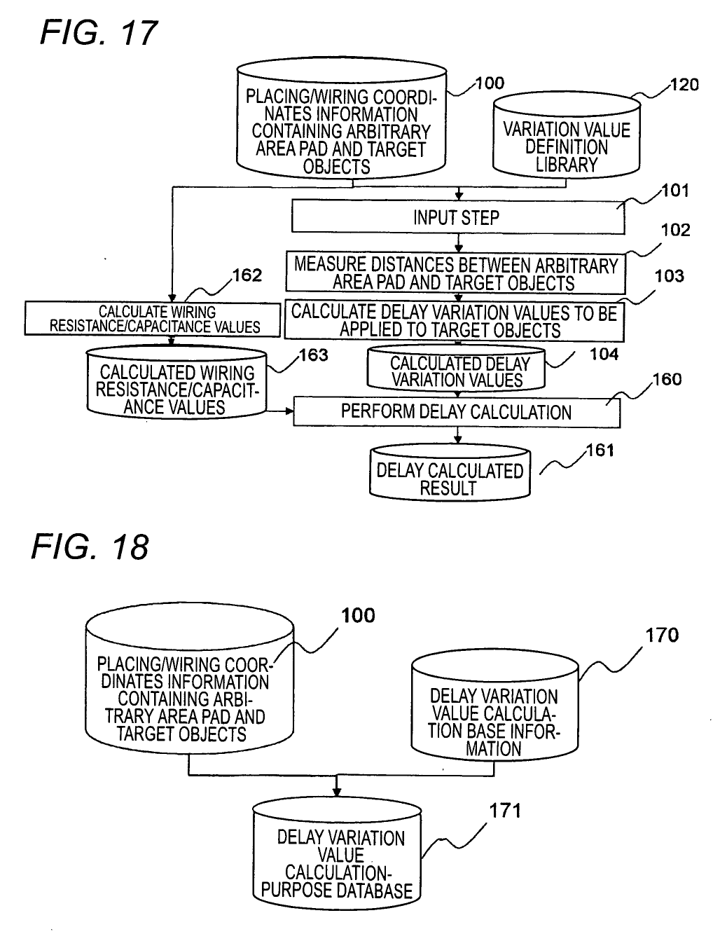

It should be understood that although the above-described embodiment mode has exemplified such an example that the delay variation value is calculated, as indicated in FIG. 17, the delay calculating method of this embodiment mode 5 may be similarly realized even in such a case that as represented in FIG. 17, the delay variation value library is employed. In this alternative case, although a detailed explanation is omitted, there is only such a different process operation that a step for reading a corresponding delay variation value from the delay variation value library 120 is added to the input step 101, and other process operations are similar to those of the flow chart shown in FIG. 16.

### Embodiment Mode 6

In an embodiment mode 6 of the present invention, a description is made of the below-mentioned method: That is, in order to calculate a delay variation value, since the delay variation value to be applied to a target object whose delay variation value is considered is calculated based upon either a situation of an object or a distance of the target object whose delay variation value is considered from a base point, while an arbitrary area pad is defined as a base point, either a library or a calculation formula every cell has been previously formed. Then, the above-described delay variation value is calculated by employing either library or the calculation formula, which is defined with respect to each of the cells.

The above-described calculation method of the embodiment mode 6 is featured as follows: That is, in addition to such a calculation that the delay variation value to be applied to the target object whose delay variation value is considered is calculated in response to the above-described distance of the target object whose delay variation value is considered, which has been described in the above-explained embodiment mode 1, the delay variation value 104 is varied in response to a situation of an area pad located at an arbitrary area pad position 110.

It is so assumed that the delay variation value 104 obtained in this embodiment mode 6 may also be utilized in the methods of the above-explained embodiment modes 3, 4, and 5.

The situation of the arbitrary area pad implies the following situation: That is, the arbitrary area pad may also obtain the delay variation values 104 which are different from each other in response to: whether or not a connecting line of an area pad is present; sorts of wiring lines (power supply-purpose wiring line, wiring line for connecting I/O element etc.) being connected in such a case that the area pad has been connected; sorts of cells present within a predetermined range (separately defined range) from an arbitrary area pad position 110; a total number of the cells; placing positions of the cells; sorts of wiring lines (clock, data, frequency, power supply); a total number of the wiring lines; widths of the wiring lines; density of the cells; and conditions of density of the wiring lines.

As previously described, in accordance with the present embodiment mode 6, the delay variation value can be calculated with respect to each of the cells, so that the delay calculations can be carried out in higher precision.

### Embodiment Mode 7

In an embodiment mode 7 of the present invention, a description is made of a database which is employed in a library which has stored thereinto placing information of an arbitrary area pad, or wiring line information; otherwise, both the above-described placing information and wiring line information; or either the information of the embodiment mode 2 or the information of the embodiment mode 6.

In other words, the embodiment mode 7 is featured by employing, as shown in FIG. 18, a delay variation value calculation-purpose database 171 provided with delay variation value calculation base information 170 in addition to the placing/wiring coordinate information 100 containing the arbitrary area pad and the target object as previous explained in the embodiment mode 2 as the library.

In this case, the delay variation value calculation-purpose database 171 corresponds to such a database into which the placing/wiring coordinates information 100 containing the arbitrary area pad and the target object, and the delay variation value calculation base information 170 have been stored. This delay variation value calculation-purpose database 171 is utilized in the delay variation value calculating step 103 for applying the delay variation value to the target object in the above-described embodiment modes 1, 3, 4, and 5, while referring to the above-described database 171.

As previously described, in accordance with the embodiment mode 7, based upon both the placing/wiring coordinates information of the target object, and the delay variation value calculation information every cell, the delay variation value which is applied to the above-described cell can be calculated, so that the delay calculation can be carried out in higher precision.

Then, based upon the analysis result obtained in the above-described method, a layout of the above-described semiconductor integrated circuit can be designed in response to the delay variation value.

For instance, in such a region that an analysis result having a large delay value has been obtained, in order to reduce delays caused by stresses, the below-mentioned designing method is executed: That is, a width of a wiring line of a preselected region under an area pad region is made wide; dimensions of vias are increased; and a total number of the vias is increased so as to decrease the delay value.

Also, instead of this method, it is possible to alternatively employ such a method that since the layout design of the preselected region under the area pad region is changed, adverse influences caused by stresses may be reduced.

In the below-mentioned embodiment mode, a description is made of a method for reducing the adverse influences of the stresses in the preselected region under the area pad region.

### Embodiment Mode 8

In an embodiment mode 8 of the present invention, a description is made of such a method that with respect to a plurality of vias which are located in a preselected region under an area pad region, a total number of these vias are increased and/or decreased based upon a previously determined design rule in order to avoid that the vias are destroyed due to adverse influences caused by stresses.

The method of this embodiment mode 8 is featured by that a timing analysis is carried out by considering the adverse influences by the stresses caused by the area pad in accordance with the above-explained embodiment mode 1, and then, the adverse influences by the stresses are relaxed by considering this analysis result.

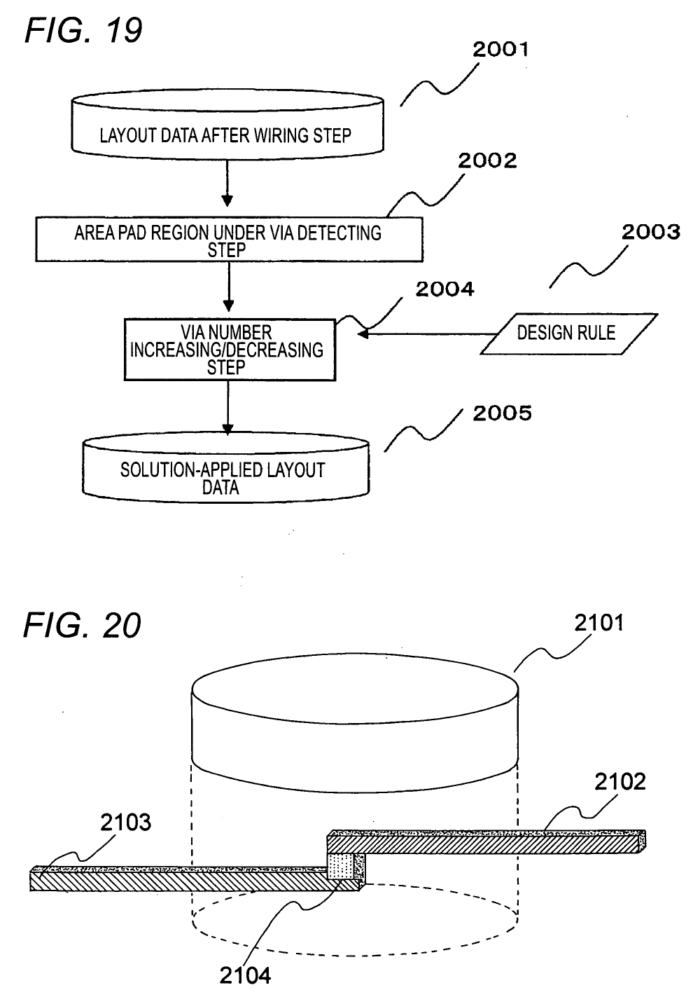

FIG. 19 is a flow chart for indicating an example of a method for designing a semiconductor device according to the embodiment mode 8.

A flow of process operations indicated in FIG. 19 will now be described as follows:

Firstly, while layout data 2001 after wiring operation is inputted, in an area pad region under via detecting step 2002, vias which are present within the preselected region under the area pad region are detected from the entered layout data 2001. While a previously determined design rule 2003 is employed as a judging material, which determines the required number of vias with respect to the preselected region under the area pad region, a total number of the vias detected in the area pad region under via detecting step 2002 is increased and/or decreased in a via number increasing/decreasing step 2004 in such a manner that the above-described design rule 2003 can be satisfied, so that solution-applied layout data 2005 is produced.

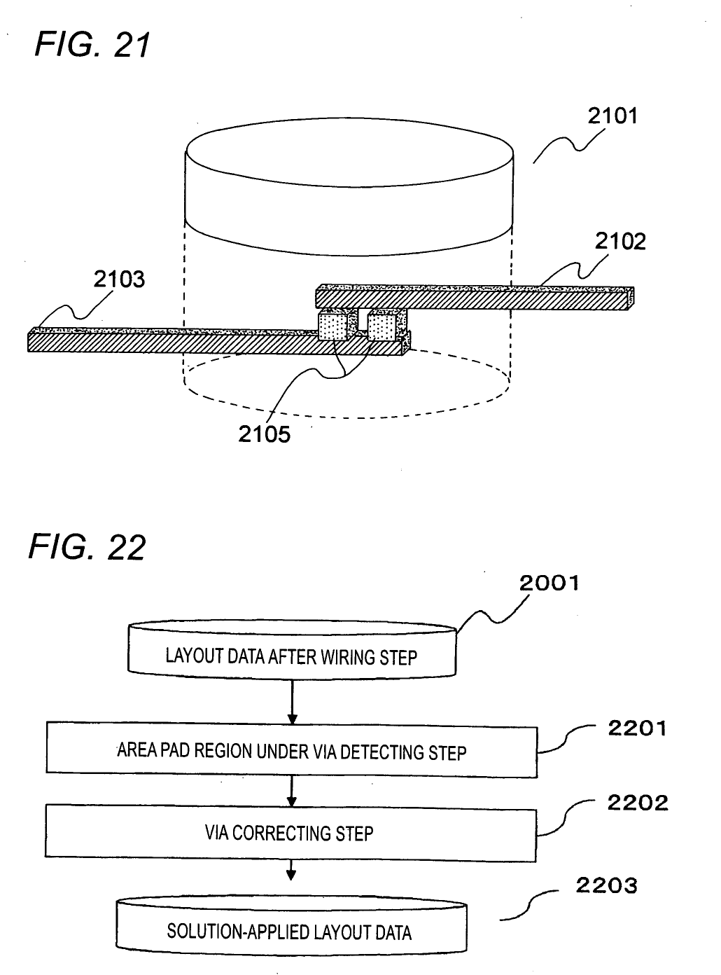

FIG. 20 shows a wiring line structural example of layout data before the designing method indicated in FIG. 19 is executed, namely, FIG. 20 represents a wiring line 2102, another wiring line 2103, and a via 2104, which are located under an area pad 2101. The via 2104 connects the wiring line 2102 to the wiring line 2103. Since the above-described wiring line structure is processed in accordance with the process operations defined in the flow chart shown in FIG. 19, as represented in FIG. 21, the via 2104 which connects the wiring line 2102 to the wiring line 2103, which are present under the area pad region, can be increased to a plurality of vias 2105.

As previously described, in accordance with the present embodiment mode 8, since the number of vias which are present under the area pad area can be increased, it is possible to avoid that the vias located under the area pad are destroyed (namely, electric connection is destroyed) which is caused by the stresses.

A via may be formed by filling an electric conductive film which constitutes a wiring line layer into a via hole formed in an interlayer insulating film. When a region where a via is present is compared with another region where a via is not present, the region where the via is present is the electric conductive film, whereas the region where the via is not present is constructed of the interlayer insulating film. In general, since an electric conductive film is constituted by a closer film than an interlayer insulating film, the electric conductive film has a higher mechanical strength. As a consequence, a total number of vias is increased in order to increase mechanical strengths, so that adverse influences by stresses can be reduced. Also, in case of such vias which connect the same layers to each other, since a total number of these vias is increased, current paths are increased, so that wiring resistance values can be reduced.

### Embodiment Mode 9

In an embodiment mode 9 of the present invention, a description is made of a method for causing vias not to be located in a preselected region under an area pad in order that an adverse influence of stresses under the area pad region is not given to the vias.

The embodiment mode 9 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

FIG. 22 is a flow chart for describing a method of designing a semiconductor device according to the embodiment mode 9.

Subsequently, a description is made of a flow of process operations indicated in FIG. 22.

Firstly, while layout data 2001 after wiring operation is inputted, in an area pad region under via detecting step 2201, vias which are present within the preselected region under the area pad region are detected from the entered layout data 2001. Next, with respect to the vias detected in the area pad region under via detecting step 2201, in a via correcting step 2202, a wiring line correction is performed in such a manner that any via is not present in a preselected region under the area pad region, so that solution-applied layout data 2203 is produced.

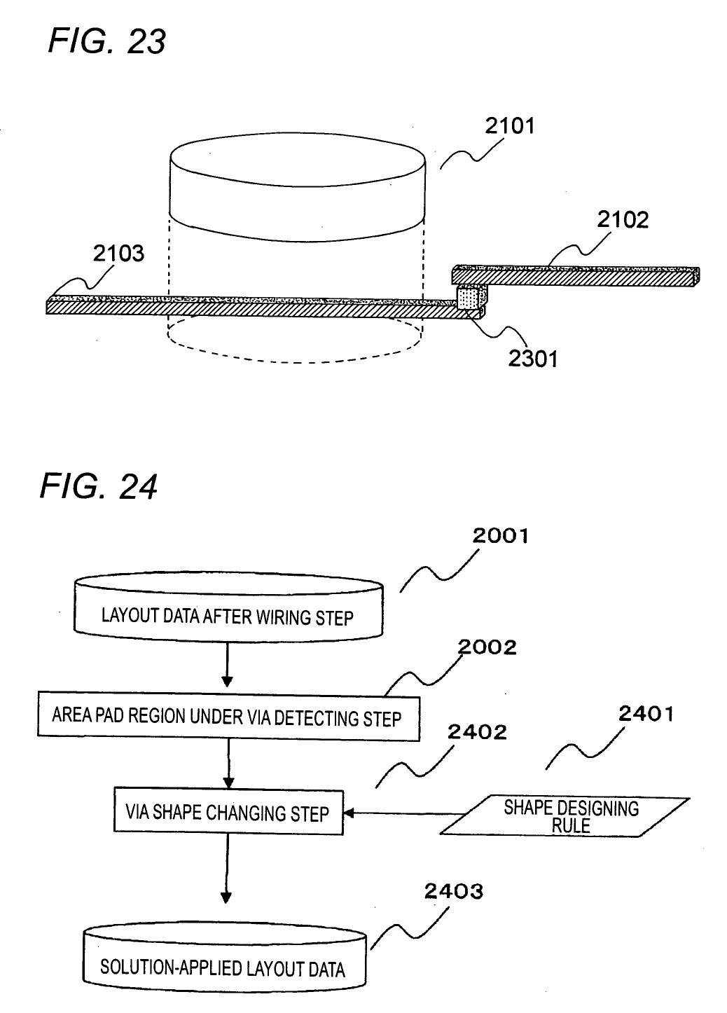

FIG. 23 shows a wiring line structural example of layout data before the designing method indicated in FIG. 22 is executed, namely, FIG. 23 represents a wiring line 2102, another wiring line 2103, and a via 2301, which are located under an area pad 2101. Since the above-described wiring line structure is processed in accordance with the process operations defined in the flow chart shown in FIG. 22, as represented in FIG. 23, such a condition that the via 2301 which connects the wiring line 2102 to the wiring line 2103, which are present under the area pad region, is not present in the preselected region under the area pad region can be produced. A position for forming the via 2301 is determined as such a region that adverse influences caused by stresses under the area pad region are detected, and then, an adverse influence caused by a stress becomes smaller than, or equal to a predetermined value.

As previously described, in accordance with the embodiment mode 9, the layout in which the via was present in the preselected region under the area pad region can be formed as the data. As a result, it is possible to avoid that the via is destroyed by receiving the stresses by the area pad.

### Embodiment Mode 10

In an embodiment mode 10 of the present invention, a description is made of such a method that a shape of a wiring line is changed which is connected to a via present in a preselected region under an area pad region so as to prevent destruction of the via which is caused by an adverse influence of stresses.

The embodiment mode 10 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

FIG. 24 is a flow chart for describing a method of designing a semiconductor device according to the embodiment mode 10.

Subsequently, a description is made of a flow of process operations indicated in FIG. 24.

Firstly, while layout data 2001 after wiring process is inputted, in an area pad region under via detecting step 2201, vias which are present within the preselected region under the area pad region are detected from the entered layout data 2001. Next, with respect to the vias detected in the area pad region, in a via shape changing step 2402, shapes of wiring lines located above/under the vias are changed based upon a previously determined shape designing rule 2401. As a result, solution-applied layout data 2403 after the via shapes have been changed is produced.

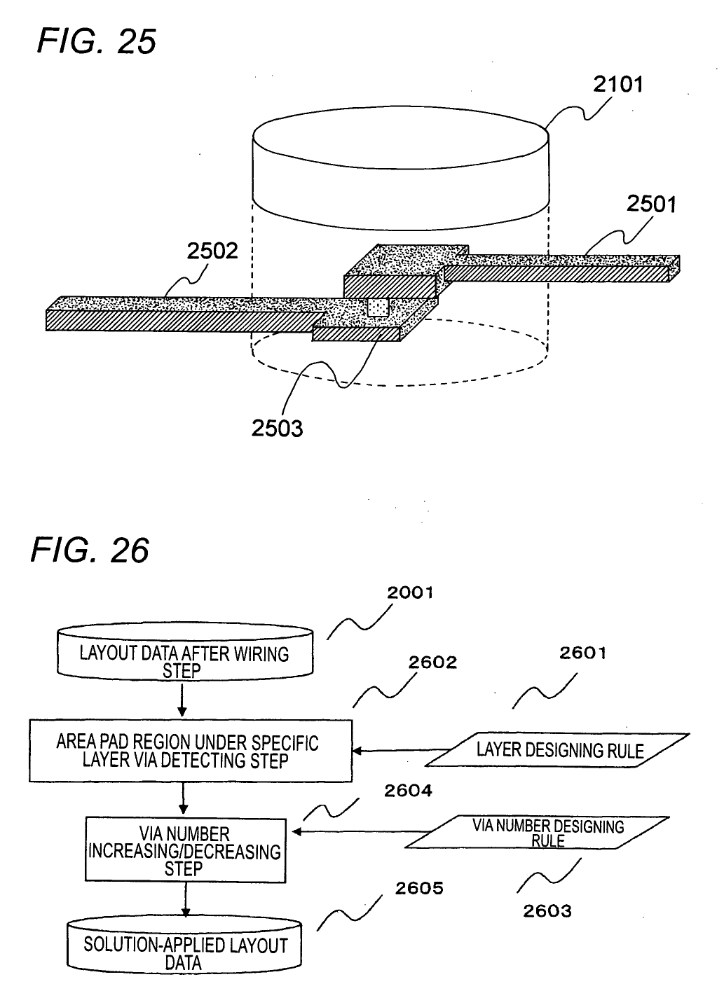

The layout data shown in FIG. 20 is made as a wiring line structural example of the layout data before the designing method shown in FIG. 24 is carried out. In accordance with this layout data, a via 2104 is represented which connects an upper-grade wiring layer 2102 to a lower-grade wiring layer 2103, which are located under an area pad 2101. Since this wiring line structure is processed by the process operations of the flow chart represented in FIG. 24, as indicated in FIG. 25, wiring layers to be connected to a via 2503 located under the area pad region are made in a pad shape in such a manner that a width of the wiring layer becomes wide at a peripheral portion of a via hole, so that shapes of the wiring layers are changed to become a wiring line 2501 and another wiring line 2502.

As previously described, in accordance with the embodiment mode 10, the shapes of the upper and lower wiring lines of the via present under the area pad region are changed into such shapes capable of enduring the stresses. As a result, it is possible to prevent the via from the destruction.

### Embodiment Mode 11

In an embodiment mode 11 of the present invention, a description is made of such a method that with respect to a plurality of vias which are connected to a specific wiring layer and are located in a preselected region under an area pad region, a total number of these vias are increased and/or decreased based upon a previously determined design rule in order to avoid that the vias are destroyed due to adverse influences caused by stresses.

The method of this embodiment mode 11 is featured by that a timing analysis is carried out by considering the adverse influences by the stresses caused by the area pad in accordance with the above-explained embodiment mode 1, and then, the adverse influences by the stresses are relaxed by considering this analysis result.

In general, while multilayer wiring methods have been popularized in current LSI design, there are some cases that 6 layers or more layers of wiring layers are employed. In such a case that an area pad is employed in such an LSI design, wiring lines of plural layers are present under a region of the area pad, and furthermore, a plurality of vias are located under this region. The embodiment mode 8 has described the method for changing the total number of all vias present under the area pad region. However, in the case of a multiple wiring layer, there are some possibilities that destruction of vias caused by adverse influences of stresses may be avoided by merely changing a total number of only such vias that are present in upper wiring layers located in the multiple wiring layers. Accordingly, in the present embodiment mode 11, a description is made of a method for changing a total quantity of vias that have been connected only to a specific wiring layer.

FIG. 26 is a flow chart for indicating an example of a method for designing a semiconductor device according to the embodiment mode 11.

A flow of process operations indicated in FIG. 26 will now be described as follows:

Firstly, while layout data 2001 after wiring process is inputted, in an area pad region under via detecting step 2602, a detection is made whether or not specific via layer determined in a previously determined layer designing rule 2601 is present within a preselected region under an area pad region. Next, while a designing rule 2603 is employed as a judging material, in which a total number of vias required for the preselected region under the area pad region has been previously determined, the number of the vias detected in an area pad region under specific layer via detecting step 2602 is increased and/or decreased in a via number increasing/decreasing step 2604, so that solution-applied layout data 2605 is produced. A wiring structural example which is produced in the flow chart according to the embodiment mode 11 shown in FIG. 26 is made as follows: That is, the wiring structure shown in FIG. 21 explained in the above-described embodiment mode 8 is made similar to the uppermost layer under the area pad, and a lower layer of this wiring structural example is made as the normal structure.

As previously described, in accordance with the present embodiment mode 11, since the number of vias which connect the specific wiring layer present under the area pad area is changed, it is possible to avoid that the vias located under the area pad are destroyed.

In the above-described embodiment mode 11, only the vias that connect two layers of the uppermost layer have been processed. Alternatively, depending upon a restriction of layout, vias for connecting layers except for the uppermost layer may be processed. As a result, strengths of a region under the area pad may be improved, so that a change in shapes under the area pad region may be avoided.

Also, this alternative method may be applied not only to the shape change, but also another method for performing the process operation only to a partial layer as explained in the example where the total number of the vias are increased in the embodiment mode 8. As a result, strengths of regions under the area pad region may be improved. Apparently, this alternative method may also be applied to a semiconductor integrated circuit device having a multilayer wiring structure.

Also, as described in the embodiment mode 9, as to a structure for avoiding a formation of vias, vias are not formed in all of regions under the area pad region. However, since the above-described timing analysis is carried out, by considering the stresses, vias may be alternatively formed with respect to a wiring line of such a region whose delay value is not large.

### Embodiment Mode 12

In an embodiment mode 12 of the present invention, a description is made of such a method that since there is no via in a previously designated layer within a preselected area under an area pad region, destruction of vias caused by stresses can be prevented. For example, such a layer that constitutes a signal line is designated, while the signal line layer corresponds to such a layer that largely gives an adverse influence to operation of an LSI due to delays.

The method of this embodiment mode 12 is featured by that a timing analysis is carried out by considering the adverse influences by the stresses caused by the area pad in accordance with the above-explained embodiment mode 1, and then, the adverse influences by the stresses are relaxed by considering this analysis result.

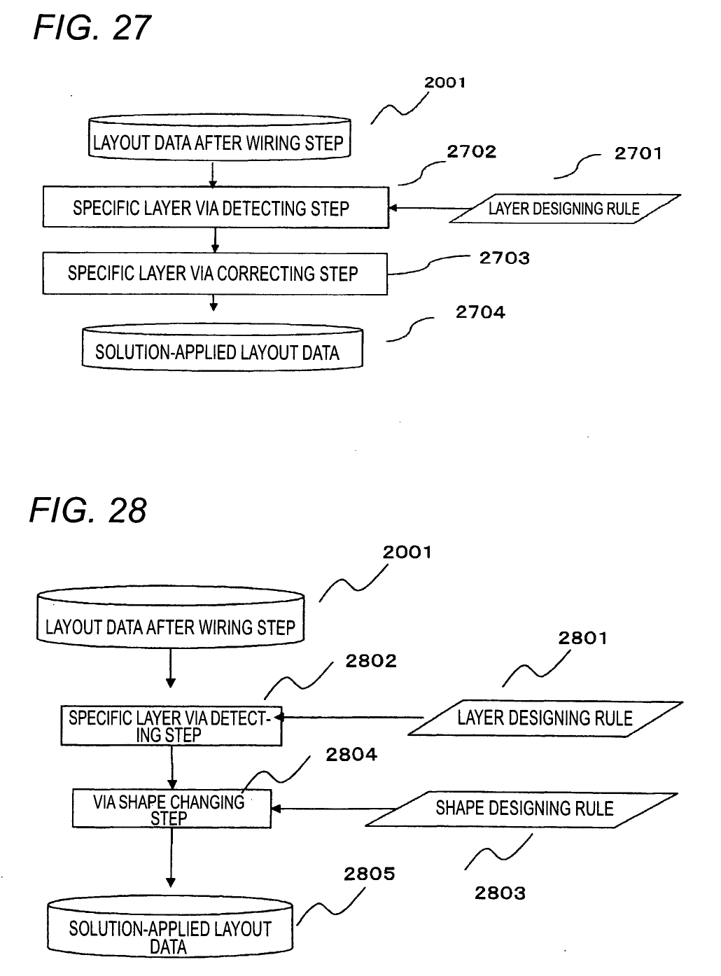

FIG. 27 is a flow chart for indicating an example of a method for designing a semiconductor device according to the embodiment mode 12.

A flow of process operations indicated in FIG. 27 will now be described as follows:

Firstly, while layout data 2001 after wiring process is inputted, in a specific layer via detecting step 2702, in such a case that a specific via layer determined based upon a previously determined layer designing rule 2701 is located within a preselected region under the area pad region, this specific via layer is detected. Next, in a specific layer via correcting step 2703, a wiring line correction is carried out with respect to the vias detected in the specific layer via detecting step 2702 in such a manner that the vias of the specific layer are not present in the preselected region under the area pad region, so that solution-applied layout data 2704 is produced. A wiring line structural example produced in the above-described flow chart of FIG. 27 is similar to that explained in the above-described embodiment mode 9 shown in FIG. 23.

As previously described, in accordance with the embodiment mode 12, the vias of the specific layer located under the area pad region are not present, it is possible to prevent the vias from the destruction. Although the destruction of the vias does not occur, in such a case that the signal line is formed, it is possible to avoid that the delay is increased. Moreover not only the vias are formed by being avoided from the preselected region under the area pad region, but also the signal line is formed by being avoided from the preselected region under the area pad region. As a result, it is possible to prevent the delay.

### Embodiment Mode 13

In an embodiment mode 13 of the present invention, a description is made of such a method that with respect to a shape of a wiring line is changed which connects vias of a specific layer present within a preselected area under an area pad region in order to avoid that the vias are destroyed due to adverse influences caused by stresses.

The method of this embodiment mode 13 is featured by that a timing analysis is carried out by considering the adverse influences by the stresses caused by the area pad in accordance with the above-explained embodiment mode 1, and then, the adverse influences by the stresses are relaxed by considering this analysis result.

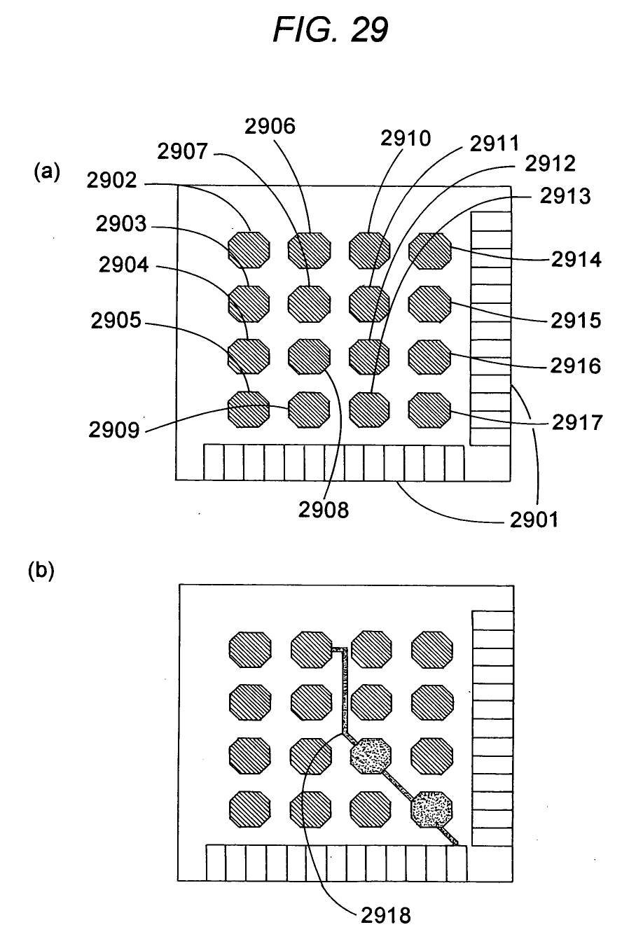

FIG. 28 is a flow chart for indicating an example of a method for designing a semiconductor integrated device according to the embodiment mode 13.

A flow of process operations indicated in FIG. 29 will now be described as follows:

Firstly, while layout data 2001 after wiring process is inputted, in a specific layer via detecting step 2802, in such a case that a specific via layer determined in a previously determined layer designing rule 2801 is located with a preselected region under an area pad region, this specific via layer is detected. In a via shape changing step 2804, with respect to the detected via layer, shapes of wiring layers located above and under the via are changed based upon a previously determined shape designing rule 2803. As a result, solution-applied layout data 2805 after the shapes of the vias have been changed is produced.

A wiring line structural example formed in accordance with the flow chart of FIG. 28 in the embodiment mode 13 is similar to the wiring line structure of FIG. 25 explained in the above-described embodiment mode 10, namely, the widths of the wiring layers located above and under the via are made wide around the via, and thus, constitute pad shapes.

As previously described, in accordance with the present embodiment mode 13, the shapes of the wiring lines located above and under the via of the specific layer present under the area pad region are changed into such shapes capable of enduring the stresses. As a result, it is possible to prevent the via from the destruction.

### Embodiment Mode 14

In an embodiment mode 14 of the present invention, a description is made of such a method that in such a case where an area pad of a dummy (namely, such pad which is not connected to I/O cell by re-wiring line) has been present, the re-wiring line is merged with the dummy pad so as to be connected, so that a crowded degree of the re-wiring lines can be solved.

The method of this embodiment mode 14 is featured by that a timing analysis is carried out by considering the adverse influences by the stresses caused by the area pad in accordance with the above-explained embodiment mode 1, and then, the adverse influences by the stresses are relaxed by considering this analysis result.

As one of such methods capable of reducing stresses applied from area pads, the below-mentioned method is conceivable: That is, a total number of area pads which are arranged on an LSI is increased in order to reduce stresses with respect to a single area pad. However, if this stress reducing method is employed, then intervals among the area pads become short. As a result, regions used for re-wiring lines are decreased. On the other hand, if a total number of area pads is increased, then there are some possibilities that there are area pads which need not be connected to I/O cells, namely dummy area pads are present. In the present embodiment mode 14, a description is made of a method capable of solving a crowed degree of re-wiring lines by utilizing the dummy area pads.

FIG. 29 is an explanatory diagram for explaining the present embodiment mode 14. FIG. 29(a) explains such a structure that a portion of an LSI formed with employment of the flip chip system has been extracted; I/O cells 2901 have been arranged at a peripheral portion of the LSI, and pads 2902 to 2917 have been present on the LSI. At this time, for example, it is so assumed that the above-described pads 2912 and 2917 correspond to dummy area pads. A dummy area pad implies such a pad that although the dummy area pad is connected to a package board, this dummy area pad is not connected to an element region within the LSI. In other words, this dummy area pad is a pad having no meaning in view of an electric aspect. In the case that such dummy pads are present, as shown in a wiring line 2918 of FIG. 29(b), even when the wiring line has such a shape merged with the pads, there is no problem.

As previously described, in accordance with the embodiment mode 14, the wiring lengths of the re-wiring lines can be reduced in minimum, and furthermore, the crowed degree of the wiring lines can be improved.

### Embodiment Mode 15

In an embodiment mode 15 of the present invention, a description is made of such a method for producing a dummy wiring line in order to relax an adverse influence of stresses caused by an area pad.

The embodiment mode 15 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

In such a case that the inventive idea of the present invention is executed, various sorts of wiring lines are produced in a similar manner to general-purpose layout design.

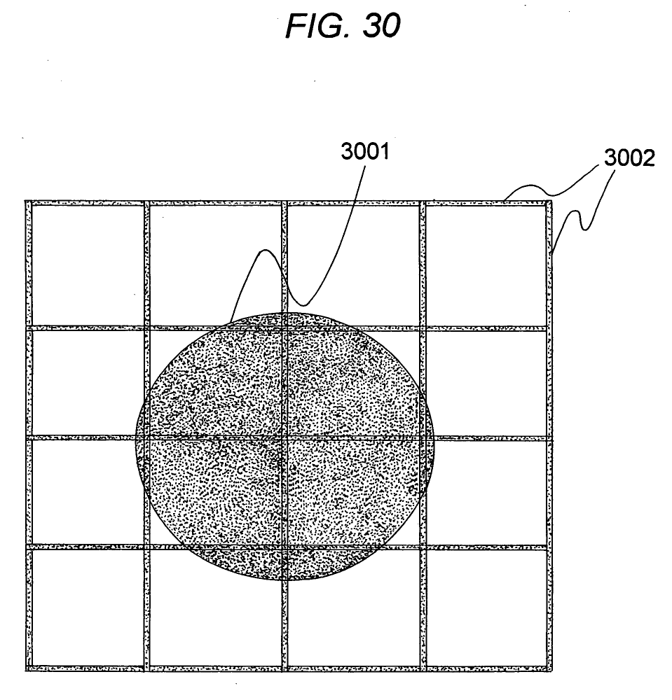

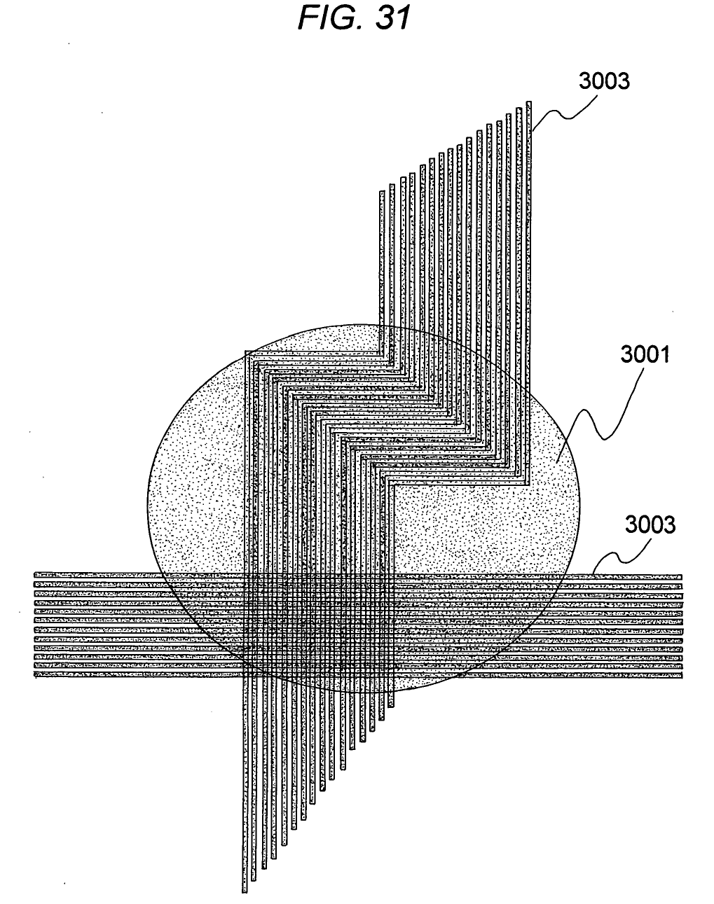

In this case, in order to relax an adverse influence of stresses caused by an area pad, such a dummy wiring line as shown in FIG. 30 is produced. FIG. 30 indicates a result obtained by that the adverse influence of the stresses caused by the area pad could be relaxed in the present invention. Reference numeral 3001 indicated in FIG. 30 denotes an area pad, and reference numeral 3002 denotes a dummy wiring line.

Similar to the general-purpose layout design, the dummy wiring line 3002 is produced in a shape of, for example, a grid shape by employing a design rule determined in a process just under the area pad 3001, or in a region which is adversely influenced by stresses of the area pad 3001. Since the dummy wiring line 3002 is produced, the adverse influence of the stresses received from the area pad 3001 may be dispersed via the dummy wiring line 3002 in order that the adverse influence by the stresses may be relaxed.

It should be noted that although the dummy wiring line has been employed in this embodiment mode 15, the influence of the stresses of the area pad may be alternatively relaxed by employing such a bus wiring line as shown in FIG. 31. FIG. 31 represents such a result obtained by relaxing the adverse influence of the stresses caused by the area pad by the bus wiring line. In this drawing, reference numeral 3001 shows an area pad, and reference numeral 3003 indicates a bus wiring line. Since the bus wiring line 3003 is provided in such a region that receives an adverse influence of stresses given from the area pad 3001, it may be understood that the adverse influence of the stresses caused by the area pad 3001 may be relaxed.

It should also be understood that instead of the dummy wiring line and the bus wiring line, a power supply wiring line may be alternatively employed.

As previously described, in accordance with the embodiment mode 15, it is possible to relax the adverse influence of the stresses caused by the area pad just under the area pad, or in the region which receives the adverse influence of the stresses caused by the area pad. As a result, it is possible to suppress a difference in delay variations between the cell which is located under the area pad, and the cell which is present in any region other than the area pad.

### Embodiment Mode 16

In an embodiment mode 16 of the present invention, a description is made of such a method that a dummy wiring line whose width is wider than a width of an area pad is produced so as to relax stresses of the area pad.

The embodiment mode 16 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

In the case of the method explained in the above-described embodiment mode 15, there are some possibilities that the adverse influence of the stresses caused by the area pad cannot be relaxed, depending upon intervals and widths of dummy wiring lines. In the present embodiment mode 16, a description is made of a method for producing such a dummy wiring line having a wider width than a width of an area pad so as to relax stresses caused by the area pad.

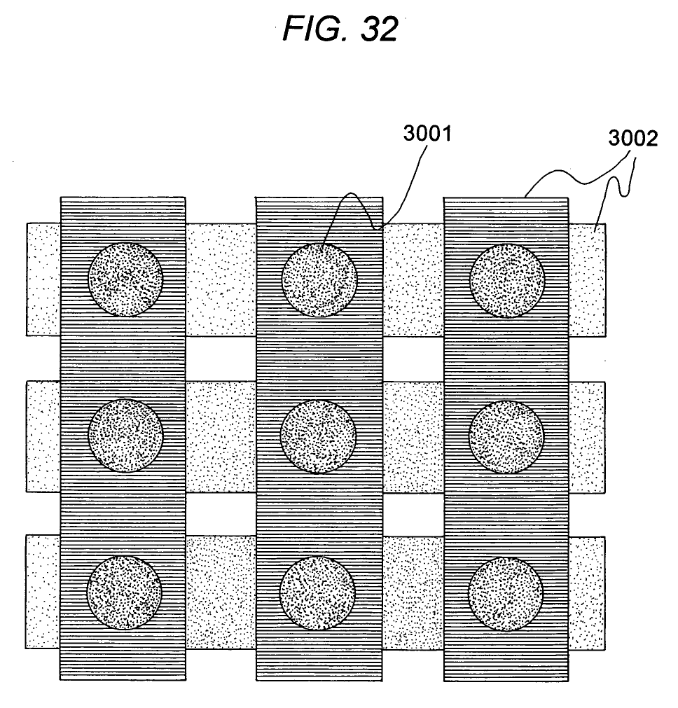

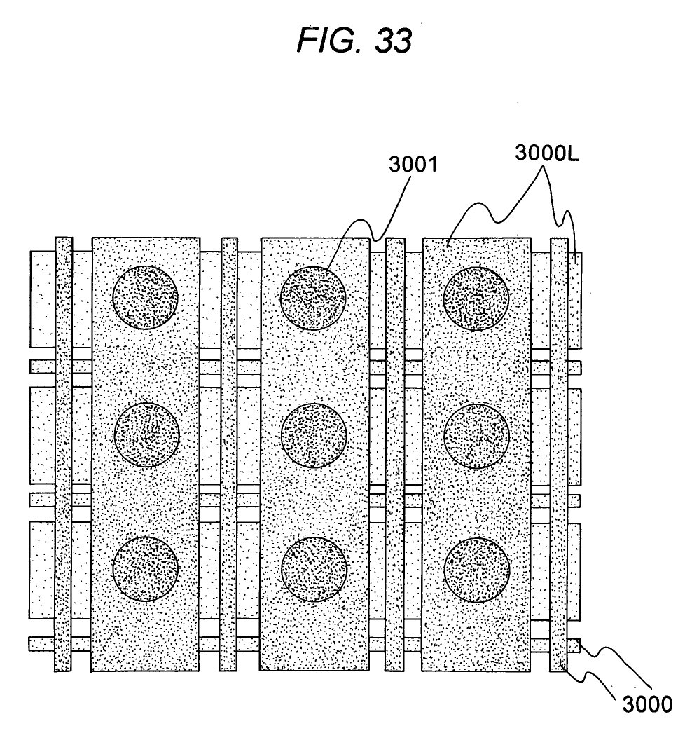

FIG. 32 indicates a result obtained by employing a dummy wiring line whose width is made wider than a width of an area pad in the embodiment mode 16 of the present invention. In FIG. 32, reference numeral 3001 shows an area pad, and reference numeral 3002 indicates a dummy wiring line. It can be seen from FIG. 32 such a fact that the dummy wiring line 3002 having the wider width than the width of the area pad 3001 has been formed. It should be noted that although the dummy wiring line has been employed in this embodiment mode 16, such a power wiring line may be alternatively employed as shown in FIG. 33. FIG. 33 represents such a result obtained by relaxing the adverse influence of the stresses caused by the area pad by the power wiring line. In this drawing, reference numeral 3001 shows an area pad, and reference numeral 3000 indicates a power wiring line. A power wiring line 3000L having a wider than a width of the area pad 3001 is provided in order to relax an adverse influence of stresses caused by the area pad 3001.

As previously described, in accordance with the present embodiment mode 16, the dummy wiring line having the width wider than the width of the area pad is produced within such a range where the adverse influence caused by the area pad is received, so that the adverse influence by the stresses can be relaxed.

### Embodiment Mode 17

In an embodiment mode 17 of the present invention, a description is made of such a method that stresses are relaxed by employing dummy wiring lines produced in a region that receives an adverse influence of the stresses given from an area pad, while construction density of the dummy wiring lines has been changed.

The embodiment mode 17 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

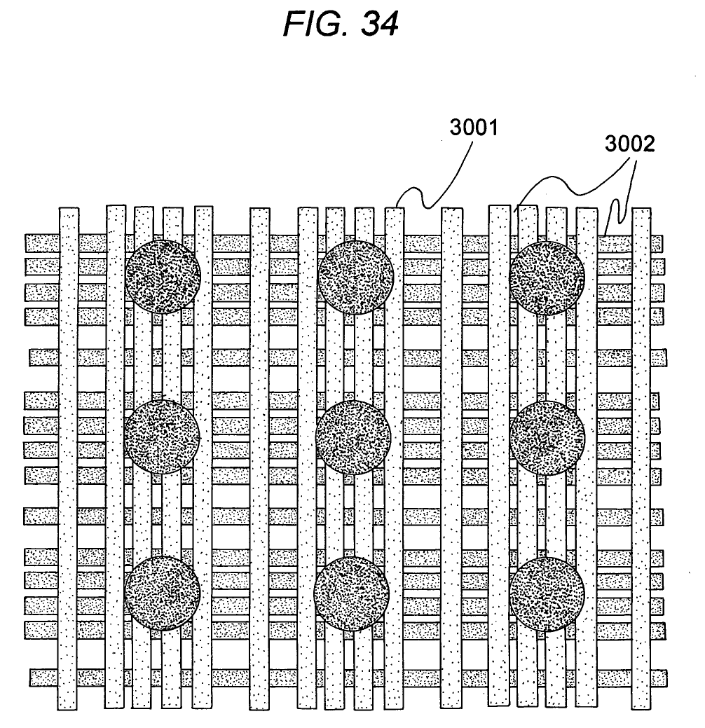

FIG. 34 represents a result obtained by that construction density of dummy wiring lines of an area pad has been changed in the embodiment mode 17 of the present invention. In FIG. 34, reference numeral 3001 shows an area pad, and reference numeral 3002 indicates dummy wiring lines. Among the dummy wiring lines 3002 formed under the area pad 3001, the construction density of such dummy wiring lines 3002 located just under the area pad 3001 has been changed and provided.

In the method described in the above-explained embodiment mode 15, since the dummy wiring line having the narrower width than the width of the area pad has been employed, there are some possibilities that the adverse influence of the stresses caused by the area pad cannot be relaxed. In the embodiment mode 17 of the present invention, among the dummy wiring lines 3002 formed within the area which is adversely influenced by the area pad, the construction density of such dummy wiring lines 3002 located just under the area pad 3001 has been changed and then been provided. For instance, construction density in the vicinity of such a region under the area pad 3001 is increased so as to arrange a large number of the dummy wiring lines 3002, and conversely, construction density in such a region which receives a small adverse influence of the stresses is decreased so as to produce a small number of the dummy wiring lines 3002.

As previously described, in accordance with the present embodiment mode 17, since the dummy wiring lines whose construction density is changed are produced, the wiring region can be secured, while the adverse influence of the stresses caused by the area pad can be firmly relaxed by the dummy wiring lines.

It should also be noted that although the dummy wiring lines have been employed in the present embodiment mode 17, power wiring lines may be alternatively employed instead of these dummy wiring lines.

### Embodiment Mode 18

In an embodiment mode 18 of the present invention, a description is made of such a method that in order to relax stresses given from an area pad, projection portions of wiring lines for connecting vias to vias are longitudinally stacked with each other from the lowermost layer up to the uppermost layer.

The embodiment mode 18 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

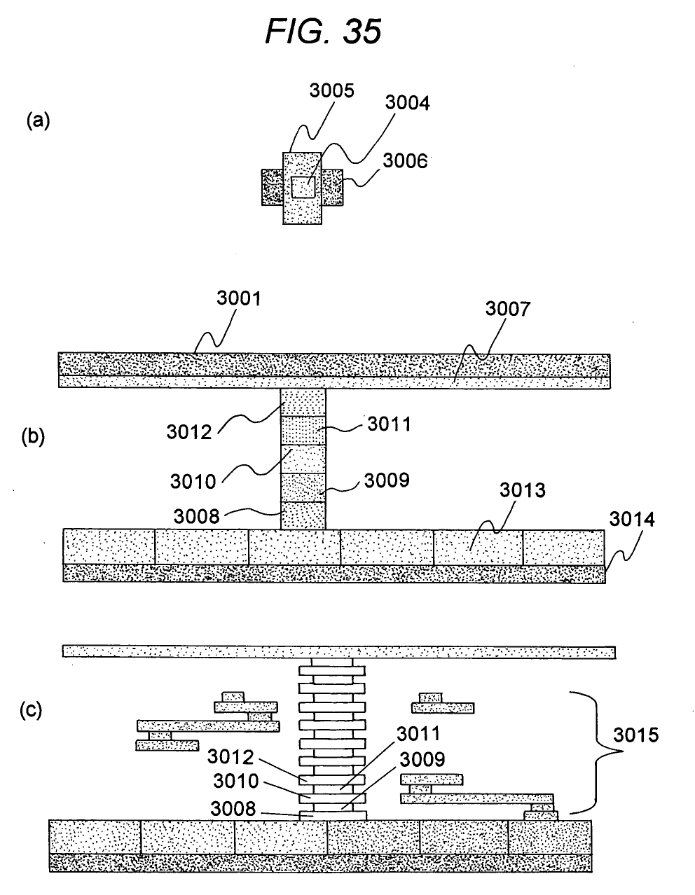

FIG. 35(a) indicates projection portions of wiring lines which connect vias to vias. In FIG. 35(a), reference numeral 3004 indicates a via hole, reference numeral 3005 shows a projection portion of a wiring line along a longitudinal direction, and reference numeral 3006 denotes represents a projection portion of a wiring line along a lateral direction.

FIG. 35(b) is a sectional view for showing a result obtained by that reinforced portions constituted by the vias and the wiring layers represented in FIG. 35(a) have been longitudinally stacked with each other from the uppermost layer up to the lowermost layer. FIG. 35(c) is an explanatory diagram for explaining an placement which contains the reinforced portions with also a peripheral circuit thereof. In FIG. 35(b) and FIG. 35(c), reference numeral 3001 shows an area pad; reference numeral 3007 indicates a protection film; reference numeral 3008 represents a first wiring layer; reference numeral 3009 shows a via which connects the first wiring layer 3007 to a second wiring layer 3010; reference numeral 3010 indicates a second wiring layer; reference numeral 3011 represents a via which connects the second wiring layer 3010 to a third wiring layer 3012; reference numeral 3012 shows a third wiring layer; reference numeral 3013 represents a standard cell; reference numeral 3014 indicates a substrate; and reference numeral 3015 indicates a peripheral wiring line. The projection portions of the wiring lines which are connected to the via 3009 with the via 3011 are longitudinally stacked with each other from the uppermost layer to the lowermost layer just under the area pad 3001, or in a region which receives an adverse influence of stresses caused by the area pad 3001. As a result, the adverse influence of the stresses received from the area pad 3001 can be relaxed.

It should also be noted that when there is neither an electric problem nor a circuitry problem, one projection portion of the wiring lines that connect the longitudinally stacked vias 3009 and 3011 may be alternatively connected to the area pad 3001.

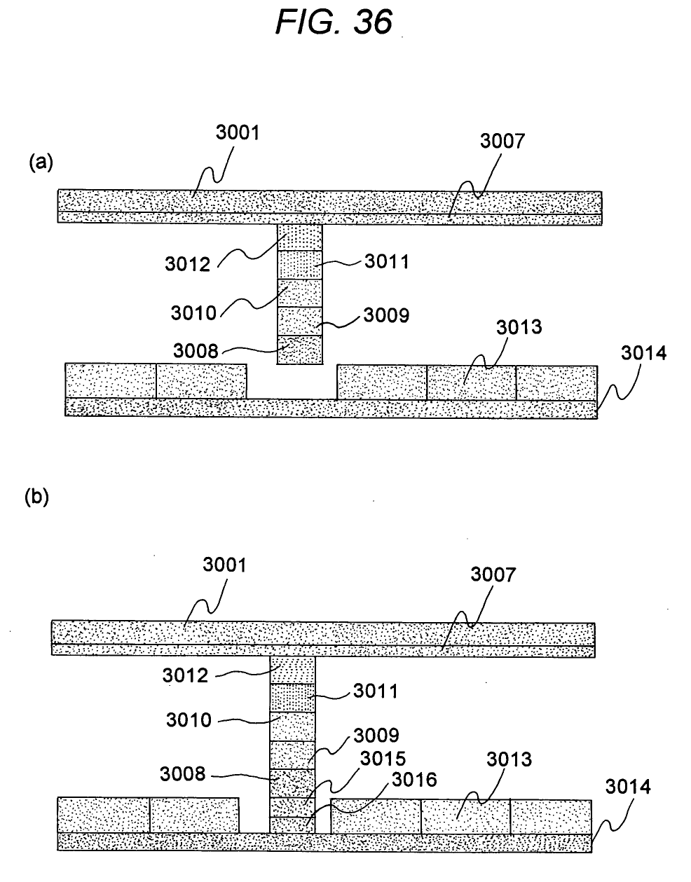

It should be understood that the standard cell 3013 has been arranged under the longitudinally stacked projection portions of the wiring lines for connecting the via 3011 to the via 3009 in this embodiment mode 18. Alternatively, as shown in FIG. 36(a), the region located just under, or around the longitudinally stacked projection portions of the wiring lines for connecting the via 3011 to the via 3009 may be alternatively formed as a region for prohibiting the placement of the standard cell 3013. FIG. 36(a) is a sectional view for showing a result obtained by that the standard cell 3013 is prohibited to be arranged. In FIG. 36(a), reference numeral 3001 shows an area pad; reference numeral 3007 indicates a protection film; reference numeral 3008 represents a first wiring layer; reference numeral 3009 shows a via which connects the first wiring layer 3007 to a second wiring layer 3010; reference numeral 3010 indicates a second wiring layer; reference numeral 3011 represents a via which connects the second wiring layer 3010 to a third wiring layer 3012; reference numeral 3012 shows a third wiring layer; reference numeral 3013 represents a standard cell; and reference numeral 3014 indicates a substrate.

It should also be noted that when there is neither an electric problem nor a circuitry problem, one projection portion of the wiring lines which connect the longitudinally stacked vias 3009 and 3011 may be alternatively connected to the substrate 3014, as represented in FIG. 36(b).

FIG. 36(b) is a sectional view for indicating such a result that a substrate has been connected to longitudinally stacked projection portions of wiring lines that connect vias to each other. In FIG. 36(b), reference numeral 3001 shows an area pad; reference numeral 3007 indicates a protection film; reference numeral 3008 represents a first wiring layer; reference numeral 3009 shows a via which connects the first wiring layer 3007 to a second wiring layer 3010; reference numeral 3010 indicates a second wiring layer; reference numeral 3011 represents a via which connects the second wiring layer 3010 to a third wiring layer 3012; reference numeral 3012 shows a third wiring layer; reference numeral 3013 represents a standard cell; reference numeral 3014 indicates a substrate; reference numeral 3015 shows a via which connects the first wiring layer 3008 to a substrate via 3016; and also, reference numeral 3016 indicates a substrate via.

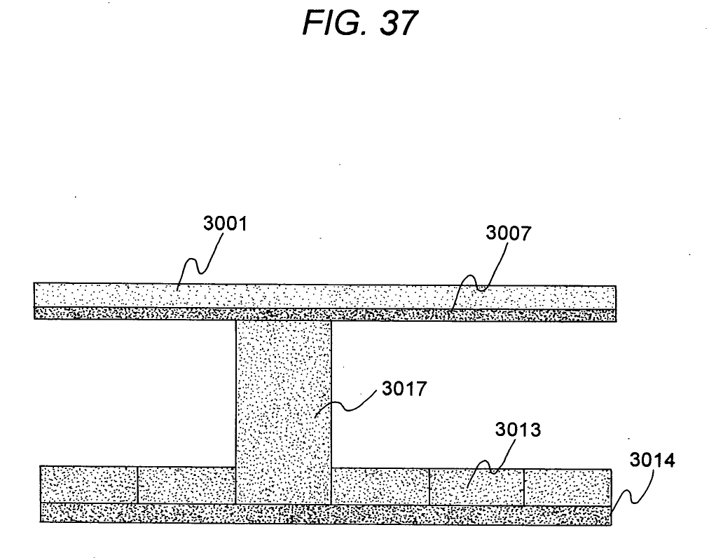

In addition, although the projection portions of the wiring lines for connecting the via to the via have been longitudinally stacked with each other in this embodiment mode 18, another placement may be alternatively employed. That is, as represented in FIG. 37, while a standard cell is previously prepared into which the projection portions of the wiring lines for connecting the longitudinally stacked vias to each other have been embedded, the above-described standard cell may be arranged at a necessary position.

FIG. 37 is a sectional view for showing a result obtained by that a standard cell has been arranged into which reinforced portions constructed by longitudinally stacked vias and wiring layers have been embedded. In FIG. 37, reference numeral 3001 shows an area pad; reference numeral 3007 indicates a protection film; reference numeral 3013 represents a standard cell; reference numeral 3014 shows a substrate; and reference numeral 3017 indicates a standard cell into which projection portions of wiring lines for connecting a via to via, which have been longitudinally stacked, has been embedded.

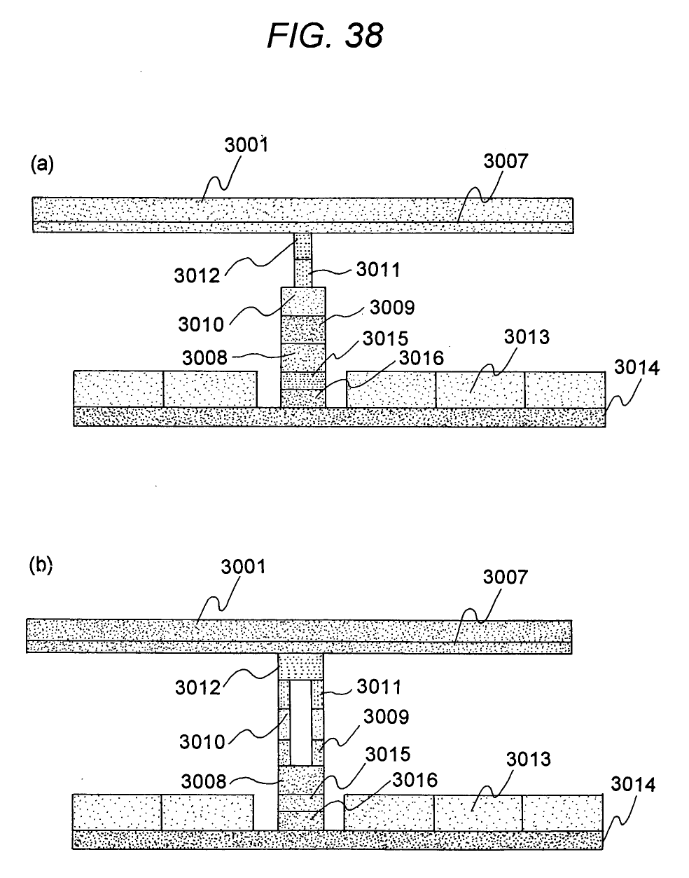

Moreover, as shown in FIG. 38(a), a portion of the projection portions of the wiring lines which connects the via to the via which have been longitudinally stacked may be alternatively made small. FIG. 38(a) is a sectional view for indicating such a result obtained by that a portion of reinforced portions constituted by vias and wiring layers that have been longitudinally stacked has been made small. In FIG. 38(a), reference numeral 3001 shows an area pad; reference numeral 3007 indicates a protection film; reference numeral 3008 represents a first wiring layer; reference numeral 3009 shows a via which connects the first wiring layer 3007 to a second wiring layer 3010; reference numeral 3010 indicates a second wiring layer; reference numeral 3011 represents a via which connects the second wiring layer 3010 to a third wiring layer 3012; reference numeral 3012 shows a third wiring layer; reference numeral 3013 represents a standard cell; reference numeral 3014 indicates a substrate; reference numeral 3015 denotes a via which connects the first wiring layer 3008 to a substrate via 3016; and reference numeral 3016 shows a substrate via. Both the via 3011 which connects the second wiring layer 3010 to the third wiring layer 3012, and the third wiring layer 3012 are made small, and thus, other wiring lines can be used as wiring line regions in the same wiring layer. As a result, it is possible to avoid unconnected lines due to a shortage of wiring line resources.

In addition, as shown in FIG. 38(b), an intermediate portion of the projection portions of the wiring lines which connects the via to the via which have been longitudinally stacked may be alternatively made small. FIG. 38(b) is a sectional view for indicating such a result obtained by that an intermediate portion of reinforced portions constituted by vias and wiring layers that have been longitudinally stacked has been made small. In FIG. 38(b), reference numeral 3001 shows an area pad; reference numeral 3007 indicates a protection film; reference numeral 3008 represents a first wiring layer; reference numeral 3009 shows a via which connects the first wiring layer 3007 to a second wiring layer 3010; reference numeral 3010 indicates a second wiring layer; reference numeral 3011 represents a via which connects the second wiring layer 3010 to a third wiring layer 3012; reference numeral 3012 shows a third wiring layer; reference numeral 3013 represents a standard cell; reference numeral 3014 indicates a substrate; reference numeral 3015 denotes a via which connects the first wiring layer 3008 to a substrate via 3016; and reference numeral 3016 shows a substrate via. The via 3009 which connects the wiring layer 3008 to the second wiring layer 3010, this second wiring layer 3010, and the via 3011 which connects the second wiring layer 3010 to the third wiring layer 3012 are made small, and further, are arranged at both ends, and thus, an intermediate region of other wiring lines can be used as wiring line regions in the same wiring layer. As a result, it is possible to avoid unconnected lines due to a shortage of wiring line resources.

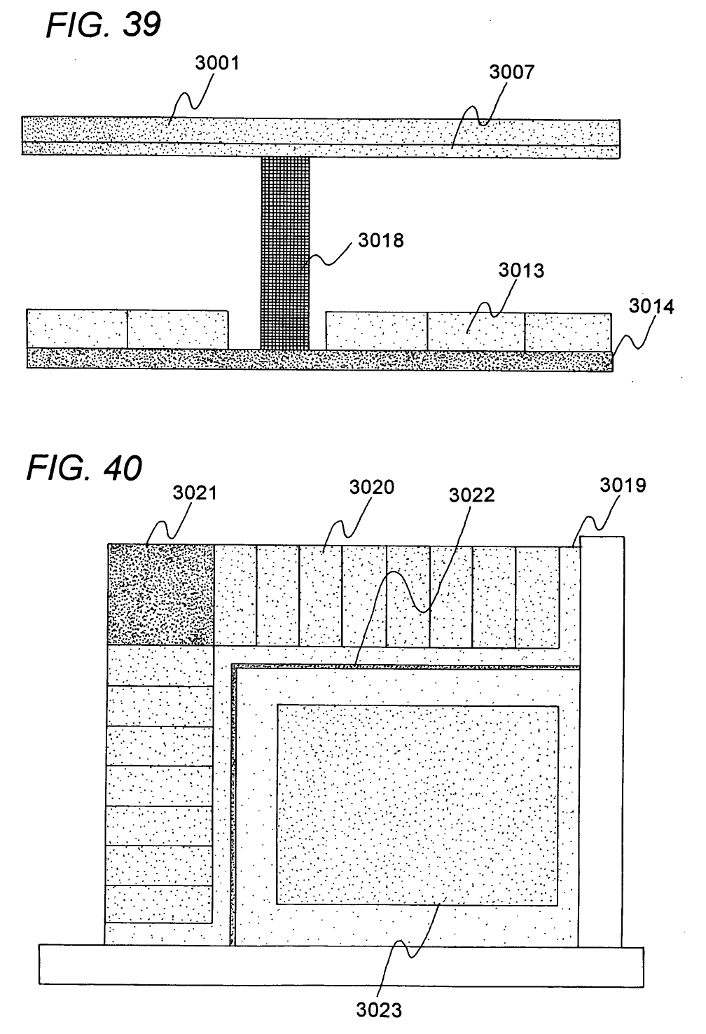

Furthermore, as represented in FIG. 39, instead of the projection portions of the wiring lines which connect the via to the via which have been longitudinally stacked, a material having higher hardness than that of the vias and the wiring layers may be alternatively employed. FIG. 39 is a sectional view for showing a result obtained by that such a material has been employed, the hardness of which is higher than the hardness of the projection portions of the wiring lines which connect the via to the via which have been longitudinally stacked. In FIG. 39, reference numeral 3001 shows an area pad; reference numeral 3007 indicates a protection film; reference numeral 3013 represents a standard cell; reference numeral 3014 indicates a substrate; and reference numeral 3018 denotes a material; the hardness of which is higher than the hardness of the reinforced portion constituted by the via and the wiring layer.

It should also be noted that as to an analog portion and a memory portion, when an adverse influence of stresses caused by the area pad 3001 is received, projection portions of the wiring lines which connect to the via to the via which have been longitudinally stacked may be alternatively provided so as to reduce the adverse influence of the stresses received from the area pad 3001.

As previously described, in accordance with the present embodiment mode 18, the longitudinally stacked projection portions of the wiring lines which connect the via to the via are produced in the area which receives the adverse influence of the stresses caused by the area pad. As a result, the adverse influence of the stresses can be relaxed.

Also, since a portion of the projection portions of the wiring lines which connect the via to the via which have been longitudinally stacked is reduced, the wiring resource of other wiring lines can be increased. As a consequence, it is also possible to avoid an un-connected line due to a shortage of wiring resources.

### Embodiment Mode 19

In an embodiment mode 19 of the present invention, a description is made of such a method that since projection portions of wiring lines which connect vias to other vias are provided at a place where a crowded degree of wiring lines is low, a reduction of a wiring resource can be prevented, and furthermore, an adverse influence of stresses caused from an area pad can be relaxed.

The embodiment mode 19 is featured by that a timing analysis is carried out by considering an adverse influence of stresses caused by an area pad in accordance with the above-described embodiment mode 1 and the like, and then, the adverse influence of the stresses is relaxed by taking account of the result of this timing analysis.

In such a case that projection portions of wiring lines for connecting vias to vias are longitudinally stacked from the uppermost layer to the lowermost layer just under an area pad, or a region which receives an adverse influence of stresses caused by the area pad, there are some possibilities that other wiring lines constitute a disturbance. As a result, wiring regions may be decreased, so that an un-connected line may occur due to a shortage of wiring resource.

As a consequence, in the embodiment mode 19, the longitudinally stacked projection portions of the wiring lines that connect the vias to the vias are provided at the place where the crowded degree of the wiring lines is low. FIG. 40 is a simplified diagram for representing an upper left corner of a semiconductor integrated circuit. In FIG. 40, reference numeral 3019 indicates a semiconductor integrated circuit; reference numeral 3020 shows an I/O cell; reference numeral 3021 represents a corner cell; reference numeral 3022 indicates a core area; and reference numeral 3023 shows a block. For example, the place where the crowded degree of the wiring lines is low corresponds to four corners of the semiconductor integrated circuit 3019, a region located on the I/O cell 3020, a region located on the corner cell 3021, four corners of the core area 3022, four corners within the block 3023, a region located on a staggered I/O cell, a region located on a spacer cell, and the like.

In accordance with the present embodiment mode 19, the longitudinally stacked reinforced portions constituted by the vias and the wiring layers are provided at such positions having small probabilities that other wiring lines pass through. As a consequence, it is possible to avoid such a fact that other wiring lines constitute a disturbance, so that wiring regions are decreased, and therefore, an unconnected line occurs due to a shortage of wiring resource.

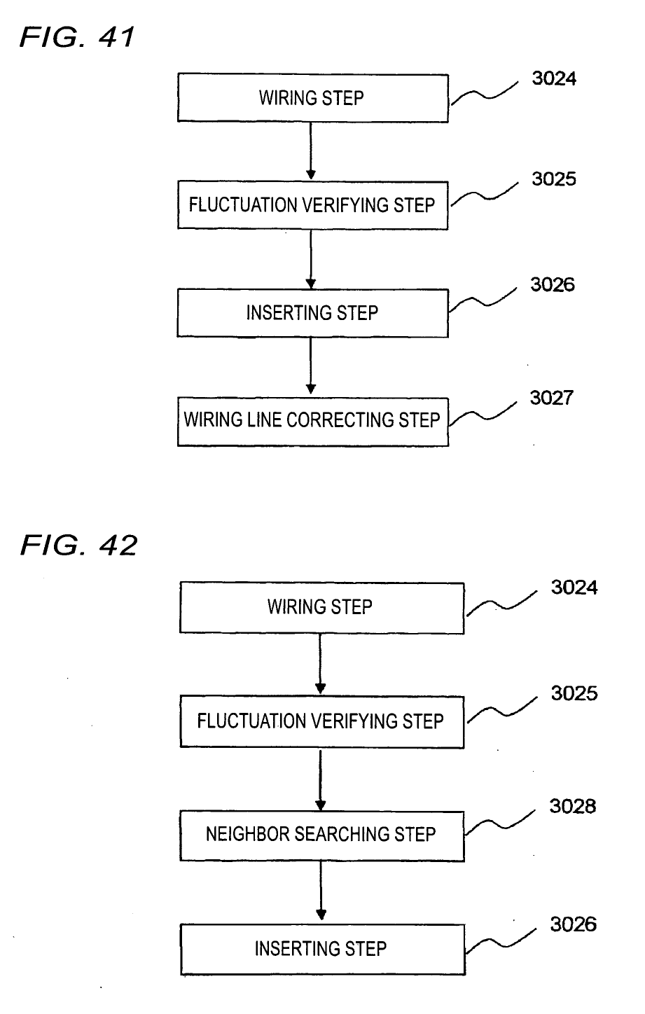

As previously described, in the embodiment mode 19, the timing analysis is carried out by considering the stresses caused by the area pad; the timing analysis result is considered; and furthermore, the projection portions of the wiring lines for connecting the vias to the vias are longitudinally stacked at the position having the small possibility that other wiring lines pass through. Alternatively, as indicated in a flow chart of FIG. 41, another method may be realized: That is, in addition to the timing analysis based upon the stresses, verification as to an placing variation of cells is carried out; and then, the longitudinally stacked projection portions of the wiring lines for connecting the vias to the vias may be arranged at such a position that the placing variation of the cells presently occurs. FIG. 41 is a flow chart for describing such process operations that after the cell placing variation has been carried out, the longitudinally stacked reinforced portions constituted by the vias and the wiring layers are arranged.

In this flow chart, reference numeral 3024 shows a wiring step; reference numeral 3025 indicates a variation verifying step; reference numeral 3026 represents an inserting step; and reference numeral 3027 indicates a wiring line correcting step. Similar to a general-purpose layout designing method, after a floor plan has been decided, in the wiring step 3024, wiring processes are performed among the respective blocks, the respective standard cells, and the like. Next, in the variation verifying step 3025, such a region which receives an adverse influence of stresses caused by an area pad is detected. In the inserting step 3026, the longitudinally stacked projection portions of the wiring lines for connecting the vias to the vias are arranged at positions where variations have been produced by receiving the adverse influence of the stresses caused by the area pad, which had been detected in the variation verifying step 3025. In the wiring line correcting step 3027, the wiring lines are corrected in such a manner that both the longitudinally stacked projection portions of the wiring lines for connecting the vias to the vias, and various sorts of the wiring lines formed in the wiring step 3024 can satisfy various sorts of design rules which have been determined based upon a process rule. The above-described projection portions of the wiring lines have been arranged in the inserting step 3026.

Also, in the embodiment mode 19, the timing analysis is carried out by considering the stresses caused by the area pad; the timing analysis result is considered; such a region which receives the adverse influence of the stresses by the area pad is detected so as to specify a position; furthermore, the projection portions of the wiring lines for connecting the vias to the vias are longitudinally stacked at the specified position. Alternatively, as represented in a flow chart of FIG. 42, another method may be employed. That is, such a position may be specified which is located in the vicinity of the above-described position specified in the variation verifying step 3025, and moreover, which can satisfy various sorts of design rules with respect to other wiring lines even when the projection portions of the wiring lines for connecting the vias to the vias are longitudinally stacked. Then, the longitudinally stacked projection portions of the wiring lines for connecting the vias to the vias may be alternatively arranged at this specific position. FIG. 42 shows such a flow chart that the projection portions of the wiring lines are arranged after the neighbor region is searched. In this flow chart, reference numeral 3024 shows a wiring step; reference numeral 3025 indicates a variation verifying step; reference numeral 3028 shows a neighbor searching step; and reference numeral 3026 represents an inserting step. Similar to a general-purpose layout designing method after a floor plan has been decided, in the wiring step 3024, wiring processes are performed among the respective blocks, the respective standard cells, and the like.

Next, in the variation verifying step 3025, such a region which receives an adverse influence of stresses caused by an area pad is detected. In the neighbor searching step 3028, such a position is specified which is located in the vicinity of the position specified in the variation verifying step 3025, and furthermore, which can satisfy various sorts of design rules which have been determined based upon the process rule even when the reinforced portions constituted by the vias and the wiring line layers are longitudinally stacked. In the inserting step 3026, at such a position that the adverse influence of the stresses by the area pad detected in the neighbor searching step 3028 was received, so that the variation has occurred, and also, at the neighbor position which can satisfy various sorts of the above-described design rules even when the projection portions of the wiring lines for connecting the vias to the vias are longitudinally stacked, the longitudinally stacked projection portions for connecting the vias to the vias are arranged. Since the above-described steps are executed, the longitudinally stacked projection portions of the wiring lines for connecting the vias to the vias can be arranged at the location which can satisfy the various sorts of design rules determined based upon the process rule. As a result, such a wiring process capable of satisfying the design rule is no longer required after the projection portions of the wiring lines have been arranged. Also, it is possible to avoid that the variation of the region occurs which receives the adverse influence of the stresses caused by the area pad.

It should also be noted that in the neighbor searching step 3028, it is also possible to alternatively specify such a position which is located in the vicinity of the position specified in the variation verifying step 3025, which can satisfy the various sorts of design rules, and furthermore, in which no standard cell is present. Since the position in which the standard cell is not present is specified, it is possible to avoid that the adverse influence of the stresses received from the area pad 3001 is given to such a standard cell located just below this area pad 3001 through the longitudinally stacked projection portions of the wiring lines which connect the vias to the vias.

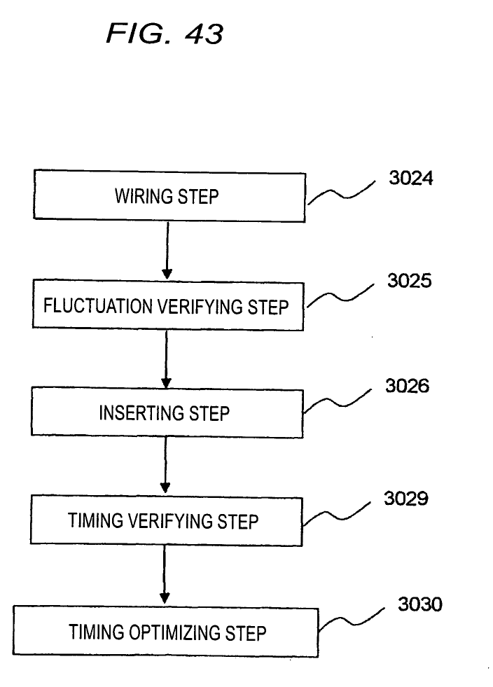

In the above-described embodiment mode 19, the region that receives the adverse influence of the stresses caused by the area pad has been detected, and then, the projection portions of the wiring lines for connecting the vias to the vias have been longitudinally stacked on the specific position. However, since the projection portions of the wiring lines for connecting the vias to the vias are longitudinally stacked, there are some possibilities that a coupling capacitance generated among the wiring lines of the same layers located in the vicinity of the projection portions is increased. Since the capacitance of the wiring lines becomes large, which constitutes one element of crosstalk and power consumption, there is such a risk that the crosstalk may occur and the power consumption may be increased. As a result, after the projection portions of the wiring lines for connecting the vias to the vias has been longitudinally stacked, both the timing verification and the timing optimizing process may be alternatively carried out. FIG. 43 is a flow chart for describing that the timing verification and the optimizing process are executed.

The flow chart of FIG. 43, reference numeral 3025 indicates a variation verifying step; reference numeral 3026 shows an inserting step; reference numeral 3029 denotes a timing verifying step; and reference numeral 3030 represents a timing optimizing step. Similar to a general-purpose layout designing method, after a floor plan has been decided, in the wiring step 3024, wiring processes are performed among the respective blocks, the respective standard cells, and the like. Next, in the variation verifying step 3025, such a region which receives an adverse influence of stresses caused by an area pad is detected. In the inserting step 3026, the longitudinally stacked projection portions of the wiring lines for connecting the vias to the vias are arranged at such a position that the adverse influence of the stresses by the area pad detected in the variation verifying step 3025 was received, so that the variation has occurred. In the timing verifying step 3029, the longitudinally stacked projection portions of the wiring lines for connecting the vias to the vias have been arranged, so that a coupling capacitance generated among the wiring lines of the same layer in the vicinity of the projection portions of the wiring lines is changed. As a result, the timing verification is carried out so as to verify whether or not a previously determined timing restriction can be satisfied, and in addition, whether or not there is a problem related to timing such as a crosstalk. In the timing optimizing step 3030, the timing-aspect problems specified in the timing verifying step 3029 are improved by correcting the wiring lines, or by being substituted by standard cells which have the same logic and the different drivabilities.

Since the above-described steps are carried out, it is possible to avoid that the various sorts of design rules determined based upon the process rule, the crosstalk and the power consumption are deteriorated. Also it is possible to avoid that the variation of the region occurs which receives the adverse influence of the stresses by the area pad.

As previously described, in the present embodiment mode 19, the longitudinally stacked projection portions of the wiring lines for connecting the vias to the vias are provided at such a place having small possibility that other wiring lines pass through. As a result, while the wiring region is secured, the adverse influence of the stresses caused by the area pad can be relaxed.

It should also be understood that although the above-explained embodiment mode 19 has described the timing analysis by considering the adverse influence of the stresses received from the area pad, the present invention is not limited only to this area pad. Alternatively, the timing analysis may be applied with respect to other pads than the area pad, for instance, layouts of wiring lines may be corrected with respect to wiring lines located in the vicinity of an input/output pad, or protection transistors provided in input/output cells.

As previously described, in the present invention, semiconductor integrated circuits are designed based upon timing analysis by considering adverse influences of stresses received by area pads, the inventive idea of which may be especially applied to all of semiconductor integrated circuit devices having flip chip structures.

What is claimed is:

1. A method for designing a semiconductor integrated circuit device comprising: a plurality of input/output cells; an area pad; and a re-wiring line for connecting at least a portion of said area pad to said input/output cells, in which said semiconductor integrated circuit device is connected via said area pad to wiring lines formed on a package board, comprising:
a delay variation value calculating step for calculating a delay variation value which is applied to said target object, while considering an adverse influence of stresses received by that said area pad is connected to the wiring lines on said package board.

2. The method for designing a semiconductor integrated circuit device as claimed in claim 1, wherein said delay variation value calculating step corresponds to a step for calculating the delay variation value in correspondence with a distance up to said target object, while said area pad of said semiconductor integrated circuit device is defined as a base point.

3. The method for designing a semiconductor integrated circuit device as claimed in claim 1, further comprising:
a step for calculating a resistance value and a capacitance value of the wiring line by employing the delay variation value obtained in said delay variation value calculating step.

4. The method for designing a semiconductor integrated circuit device as claimed in claim 1, further comprising:
a step for performing the delay calculation by employing said delay variation value obtained in the delay variation value calculating step.

5. The method for designing a semiconductor integrated circuit device as claimed in claim 1, wherein said delay variation value calculating step calculates said delay variation value by employing a library defined with respect to each of said plural cells.

6. The method for designing a semiconductor integrated circuit device as claimed in claim 4, wherein said delay variation value calculating step includes:
a step for calculating said delay variation value by employing such a database that placing information of the target object and wiring information have been added to said library.

7. The method for designing a semiconductor integrated circuit device as claimed in claim 1, further comprising:
a step for designing a layout of said semiconductor integrated circuit device in response to the delay variation value obtained in said delay variation value calculating step.

8. The method for designing a semiconductor integrated circuit device as claimed in claim 1, further comprising:
a step for adjusting a plurality of vias within a preselected region located under a region of said area pad in response to the delay variation value obtained in said delay variation value calculating step.

9. The method for designing a semiconductor integrated circuit device as claimed in claim 8 wherein:
said step for adjusting the vias corresponds to a step for increasing a total number of said vias within the preselected region under said area pad region.

10. The method for designing a semiconductor integrated circuit device as claimed in claim 8 wherein:
said step for adjusting the vias corresponds to a step for changing shapes of the vias within the preselected region under said area pad region.

11. The method for designing a semiconductor integrated circuit device as claimed in claim 10 wherein:
said step for changing the shapes of said vias corresponds to a step for increasing the vias within the preselected region under said area pad region.

12. The method for designing a semiconductor integrated circuit device as claimed in claim 8, wherein said step for adjusting the vias corresponds to a step for decreasing a total number of said vias within the preselected region under said area pad region.

13. The method for designing a semiconductor integrated circuit device as claimed in claim 12, wherein said step for adjusting the vias corresponds to a step for adjusting that the vias are not present within the preselected region under said area pad region.

14. The method for designing a semiconductor integrated circuit device as claimed in claim 8 wherein:
said step for adjusting the vias corresponds to a step for forming dummy vias which are not electrically connected within the preselected region under said area pad region.

15. The method for designing a semiconductor integrated circuit device as claimed in claim 14, wherein:
said step for forming the dummy vias correspond to a step for forming vias which are longitudinally stacked over a plurality of wiring layers.

16. The method for designing a semiconductor integrated circuit device as claimed in claim 8 wherein:
said step for adjusting the vias corresponds to a step for adjusting that no via is present which is connected to a specific wiring layer within said predetermined region under the area pad region.

17. The method for designing a semiconductor integrated circuit device as claimed in claim 16, further comprising:
a step for designing that the specific wiring layer is not present within the preselected region under said area pad region.

18. The method for designing a semiconductor integrated circuit device as claimed in claim 16 wherein:
a shape of said specific wiring layer is changed within the preselected region under said area pad region.

19. The method for designing a semiconductor integrated circuit device as claimed in claim 16 wherein:
when said area pad is a dummy pad, the re-wiring line and said area pad are present by being merged with each other.

20. The method for designing a semiconductor integrated circuit device as claimed in claim 1, further comprising:
a step for constructing a dummy wiring line for relaxing said stresses in a region located just under said area pad, or in a region which receives the adverse influence of the stresses caused by said area pad in response to the delay variation value obtained in said delay variation value calculating step.

21. The method for designing a semiconductor integrated circuit device as claimed in claim 20 wherein:
said dummy wiring line constructing step includes:
a step for constructing the dummy wiring line whose width is wider than a width of said area pad in the region located just under said area pad, or in the region which receives the adverse influence of the stresses caused by said area pad.

22. The method for designing a semiconductor integrated circuit device as claimed in claim 20 wherein:
said dummy wiring line constructing step includes:
a step for adjusting construction density of the dummy wiring lines in the region located just under said area pad, or in the region which receives the adverse influence of the stresses caused by said area pad.

23. The method for designing a semiconductor integrated circuit device as claimed in claim 15 wherein:
said dummy wiring line constructing step includes:
said step for constructing the dummy wiring line includes:
a step for constructing projection portions of wiring lines for connecting vias to vias which have been longitudinally stacked from the uppermost layer to the lowermost layer in the region located just under said area pad, or in the region which receives the adverse influence of the stresses caused by said area pad.

24. The method for designing a semiconductor integrated circuit device as claimed in claim 23 wherein said longitudinally stacked vias are constructed at a place whose wiring crowded degree is low.

25. A designing apparatus of the semiconductor integrated circuit device recited in claim 1, which is equipped with: a plurality of input/output cells; an area pad; and a re-wiring line for connecting at least a portion of said area pad to said input/output cells, in which said semiconductor integrated circuit device is connected via said area pad to wiring lines formed on a package board;
wherein:
said designing apparatus is comprised of:
an input unit for inputting layout information; and
a delay variation value calculating unit for calculating a delay variation value which is applied to said target object, while considering an adverse influence of stresses received by that said area pad is connected to the wiring lines on said package board.

26. The designing apparatus of a semiconductor integrated circuit device as claimed in claim 25 wherein:
said designing apparatus is further comprised of:
a distance measuring unit for measuring a distance based upon said layout information, while an area pad of the target object is defined as a base point; and wherein:
said delay variation value calculating unit calculates the delay variation value in correspondence with a distance up to the target object, while said area pad of the semiconductor integrated circuit device as a base point.

27. The designing apparatus of a semiconductor integrated circuit device as claimed in claim 25, further comprising:
a wiring capacitance/resistance value calculating unit for calculating a resistance value and a capacitance value of the wiring line by employing the delay variation value obtained in said delay variation value calculating unit.

28. The designing apparatus of a semiconductor integrated circuit device as claimed in claim 25, further comprising:
a delay value calculating unit for performing the delay calculation by employing said delay variation value obtained in the delay variation value calculating unit.

29. The designing apparatus of a semiconductor integrated circuit device as claimed in claim 25 wherein:
while said delay variation value calculating unit is comprised of a library defined with respect to each of said plural cells, said delay variation value calculating unit calculates the delay variation value by employing said library.

30. The designing apparatus of a semiconductor integrated circuit device as claimed in claim 29 wherein:
said delay variation value calculating unit is comprised of such a database that placing information of the target object and wiring information have been added to said library so as to calculate said delay variation value.

31. A semiconductor integrated circuit device designed based upon the semiconductor integrated circuit device designing method recited in claim 1, wherein:
statuses of vias present within the preselected region under said area pad region are different from those of a peripheral region.

32. The semiconductor integrated circuit device as claimed in claim 31 wherein the number of said vias present within the preselected region under said area pad region are larger than those of the peripheral region.

33. The semiconductor integrated circuit device as claimed in claim 31 wherein shapes of said vias present within the preselected region under said area pad region are different from those of the peripheral region.

34. The semiconductor integrated circuit device as claimed in claim 33 wherein dimensions of said vias present within the preselected region under said area pad region are larger than those of the peripheral region.

35. The semiconductor integrated circuit device as claimed in claim 31 wherein the number of said vias present within the preselected region under said area pad region are smaller than those of the peripheral region.

36. The semiconductor integrated circuit device as claimed in claim 25 wherein there is no via within the preselected region under said area pad region.

37. The semiconductor integrated circuit device as claimed in claim 31 wherein a dummy via which is not electrically connected is provided within the preselected area under said area pad region.

38. The semiconductor integrated circuit device as claimed in claim 37 wherein said dummy via corresponds to vias which have been longitudinally stacked over a plurality of wiring layers.

39. The semiconductor integrated circuit device as claimed in claim 31 wherein there is no such a via which is connected to a specific wiring layer within the preselected region under said area pad region.

40. The semiconductor integrated circuit device as claimed in claim 39 wherein the specific wiring layer is not present within the predetermined region under said area pad region.

41. The semiconductor integrated circuit device as claimed in claim 39 wherein a shape of the specific wiring layer within the preselected region under said area pad region is different from that of another region.

42. The semiconductor integrated circuit device as claimed in claim 39 wherein when said area pad is a dummy pad, the re-wiring line and said area pad are present by being merged with each other.

43. The semiconductor integrated circuit device as claimed in claim 31 wherein a dummy wiring line for relaxing said stresses is provided in a region located just under said area pad, or in a region which receives the adverse influence of the stresses caused by said area pad.

44. The semiconductor integrated circuit device as claimed in claim 43 wherein a width of said dummy wiring line is wider than a width of the area pad in the region located just under said area pad, or in the region which receives the adverse influence of the stresses caused by said area pad.

45. The semiconductor integrated circuit device as claimed in claim 43 wherein construction density of the dummy wiring lines present in the region located just under said area pad, or in the region which receives the adverse influence of the stresses caused by said area pad is different from that of the peripheral region.

46. The semiconductor integrated circuit device as claimed in claim 38 wherein in the region located just under said area pad, or in the region which receives the adverse influence of the stresses caused by said area pad, said dummy wiring line is comprised of:
vias which have been longitudinally stacked from the uppermost layer to the lowermost layer; and
a projection portion of a wiring line connected to said vias.

47. The semiconductor integrated circuit device as claimed in claim 45 wherein said longitudinally stacked vias are constructed at a place whose wiring crowded degree is low.
